(19) United States
(12) Patent Application Publication
(10) Pub. No.: US 2014/0229646 A1
(43) Pub. Date: Aug. 14, 2014

(54) INFORMATION PROCESSING SYSTEM, METHOD AND COMPUTER-READABLE RECORDING MEDIUM

(71) Applicant: FUJITSU LIMITED, Kawasaki-shi (JP)

(72) Inventor: Yoshiyuki OHHIRA, Fuji (JP)

(73) Assignee: FUJITSU LIMITED, Kawasaki-shi (JP)

(21) Appl. No.: 14/255,246

(22) Filed: Apr. 17, 2014

Related U.S. Application Data
(63) Continuation of application No. PCT/JP2011/005896, filed on Oct. 20, 2011.

(51) Int. Cl. G06F 9/48

(52) U.S. Cl. CPC G06F 9/4812
USPC 710/262; 718/107

(57) ABSTRACT

An information processing system includes a memory that stores a first program and a second program, a first processor coupled to the memory and configured to execute the first program, and a second processor coupled to the memory and configured to delay execution of the second program until the first processor starts executing the first program.

### CROSS-REFERENCE TO RELATED APPLICATION

This application is a continuation application of International Application PCT/JP2011/005896 filed on Oct. 20, 2011, the entire contents of which are incorporated herein by reference.

### FIELD

The embodiment discussed herein are related to an information processing system, a method, and a computer-readable recording medium.

### BACKGROUND

There is a multiprocessor system including multiple processors and including shared memory to be accessed by the multiple processors. Each of the multiple processors executes, of multiple programs stored in a storage unit which the multiprocessor system includes, a program allocated thereto.

Such a multiprocessor system enables parallel execution of programs by the programs being executed at the processors. Such a multiprocessor system frequently uses shared memory. The programs are exclusively controlled so that an area within the shared memory which is used by a certain processor is not accessed by another processor.

Therefore, in order to execute a new program at the multiprocessor system, not only does an individual execution test of that new program have to be performed, but also verification has to be made that exclusive control is executed normally and processing is executed normally at the time of executing already installed programs and the new program in parallel. To deal with this, delaying the execution speed of the programs at a section specific to the new program is being studied, in order to improve the probability that the new program will perform interrupt control or exclusive control with each of the programs. According to such verification, each of the programs and the new program are executed in parallel, which enables whether or not the above exclusive control is normal to be confirmed.

An arrangement where a higher-level program allocates multiple lower-level programs to multiple processors, and the multiple lower-level programs are executed at the processors, has become mainstream. That is to say, execution timing of these programs depends on the control of the OS. Therefore, at the time of performing verification of a new program as described above, it is difficult for a user to confirm when and what kind of program is being executed, that is, execution timing thereof. Therefore, at the time of installing a new program to the system, the user executes the new program at an optional timing to accumulate execution history without recognizing the execution status of each program, and in the case that the program causes an error, browses the past execution history by tracing the history thereof. Examples of relevant literature include Japanese Laid-open Patent Publication No. 09-330279.

### SUMMARY

According to an aspect of the invention, an information processing system includes a memory that stores a first program and a second program, a first processor coupled to the memory and configured to execute the first program, and a second processor coupled to the memory and configured to delay execution of the second program until the first processor starts executing the first program.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a hardware configuration of an information processing apparatus according to a first embodiment;

FIG. 2 is a diagram illustrating a function configuration of the information processing apparatus according to the first embodiment;

FIG. 3 is a diagram illustrating a software configuration of the information processing apparatus according to the first embodiment;

FIG. 4 is a diagram illustrating a software configuration for realizing a program starting delay function according to the first embodiment;

FIG. 5 is a diagram conceptually illustrating operation of the program starting delay function according to the first embodiment;

FIG. 6 is a table illustrating a relation between instruction contents relating to the program starting delay function according to the first embodiment from a user and the operation contents of the information processing apparatus according to the first embodiment;

FIG. 7 is a flowchart of the program starting delay function according to the first embodiment;

FIG. 8 is a flowchart of the program starting delay function according to the first embodiment;

FIG. 9 is a diagram illustrating a relation between programs of a delay function unit according to the first embodiment;

FIG. 10 is a diagram illustrating a relation between each processor unit and a control table (data area for processor function unit);

FIG. 11 is a diagram illustrating a software configuration for realizing execution speed delay processing of a specific program according to the first embodiment;

FIG. 12 is a table illustrating processing contents of a program execution delay function;

FIG. 13 is a table illustrating a relation between a transition of interrupt inhibition and release statuses in the specific program, and execution speed delay processing of the specific program;

FIG. 14 is a table illustrating a relation between a transition of securing and release statuses of exclusive control in the specific program, and execution speed delay processing of the specific program;

FIG. 15 is a flowchart of processing for deciding a range where execution speed of a program is delayed;

FIG. 16 is a flowchart of the processing for deciding a range where execution speed of the program is delayed;

FIG. 17 is a diagram illustrating a software configuration for realizing an interrupt delay function according to a second embodiment;

FIG. 18 is a table illustrating a relation between instruction contents from a user and processing contents of the interrupt delay function from an input/output device;

FIG. 19 is a diagram conceptually illustrating operation of the interrupt delay function from an input/output device;

FIG. 20 is a diagram illustrating a function configuration of an information processing apparatus according to the second embodiment;

FIG. 21 is a flowchart of program execution speed delay processing.

FIG. 22 is a flowchart of the program execution speed delay processing.

FIG. 23 is a flowchart of an interrupt delay function (fourth delay function unit) from an input/output device;

FIG. 24 is a flowchart of the interrupt delay function (fourth delay function unit) from the input/output device;

FIG. 25 is a flowchart of a restarting process unit;

FIG. 26 is a diagram illustrating a software configuration for realizing an execution delay function of a specific program according to a third embodiment;

FIG. 27 is a diagram illustrating a range where execution speed of a program configured to perform interrupt control (inhibition or release) is delayed, and a range where the execution speed of the program is not delayed;

FIG. 28 is a diagram illustrating a range where execution speed of a program configured to perform control of securing and release of exclusive control is delayed, and a range where the execution speed of the program is not delayed;

FIG. 29 is a diagram illustrating a range where execution speed of a program configured to perform interrupt control (inhibition or release) and control of securing and release of exclusive control is delayed, and a range where the execution speed of the program is not delayed;

FIG. 30 is a diagram illustrating a range where execution speed of a program configured to perform interrupt control (inhibition or release) and control of securing and release of exclusive control is delayed, and a range where the execution speed of the program is not delayed;

FIG. 31 is a table illustrating processing overview of a program execution delay function;

FIG. 32 is a flowchart of a monitoring unit serving as the program execution delay function;

FIG. 33 is a flowchart of the monitoring unit serving as the program execution delay function;

FIG. 34 is a flowchart of the monitoring unit serving as the program execution delay function;

FIG. 35 is a flowchart of the monitoring unit serving as the program execution delay function;

FIG. 36 is a flowchart of a decision unit serving as the program execution delay function;

FIG. 37 is a flowchart of the decision unit serving as the program execution delay function;

FIG. 38 is a diagram illustrating a program configuration for configuring a log information data sampling function;

FIG. 39 is a flowchart of a sampling unit serving as the log information data sampling function;

FIG. 40 is a diagram illustrating a configuration of a pointer table as to a work area which is used by the program starting delay function, program execution delay function, interrupt delay function from an input/output device, and log information data sampling function;

FIG. 41 is a diagram illustrating a relation between a pointer table as to a storage area of the operation status of each processor function unit used by the program starting delay function, program execution delay function, interrupt delay function from an input/output device, and log information data sampling function;

FIG. 42 is a first table configured to store data specified from a user of an information processing apparatus;

FIG. 43 is a first memory map illustrating information of a function specified by a user within the first table configured to store contents specified from a user of an information processing apparatus;

FIG. 44 is a second memory map illustrating information regarding the specific program within the first table configured to store contents specified from a user of the information processing apparatus;

FIG. 45 is a second table which is a control table provided to each of the processor function units, and is used for recognizing the status of a program using the program starting delay function, program execution delay function, interrupt delay function from an input/output device, and log information data sampling function;

FIG. 46 is a third memory map illustrating the status display of the specific program being executed within the second table which is a control table provided to each of the processor function units;

FIG. 47 is a fourth memory map illustrating information regarding the specific program within the second table which is a control table provided to each of the processor units;

FIG. 48 is a third table configured to store interrupt information from an input/output device, and is used for the interrupt delay function from the input/output device storing interrupt information from the input/output device;

FIG. 49 is a fourth table illustrating contents of exclusive control, and is used for the program execution delay function recognizing the status of exclusive control;

FIG. 50 is a fifth table illustrating management information of log information data, and is used for the log information data sampling function managing the storage area of log information data;

FIG. 51 is a fifth memory map illustrating the status display of a program that outputs log information data within the fifth table that the log information sampling function uses; and

FIG. 52 is a sixth table illustrating contents of the storage area of log information data, and is used as the storage area of log information data sampled by the log information data sampling function.

### DESCRIPTION OF EMBODIMENTS

The disclosed technology provides, even in the case that it is difficult to control execution timing of individual programs, an information processing apparatus capable of controlling execution timing of a program in accordance with operation of another program, and a control method of the information processing apparatus.

### First Embodiment

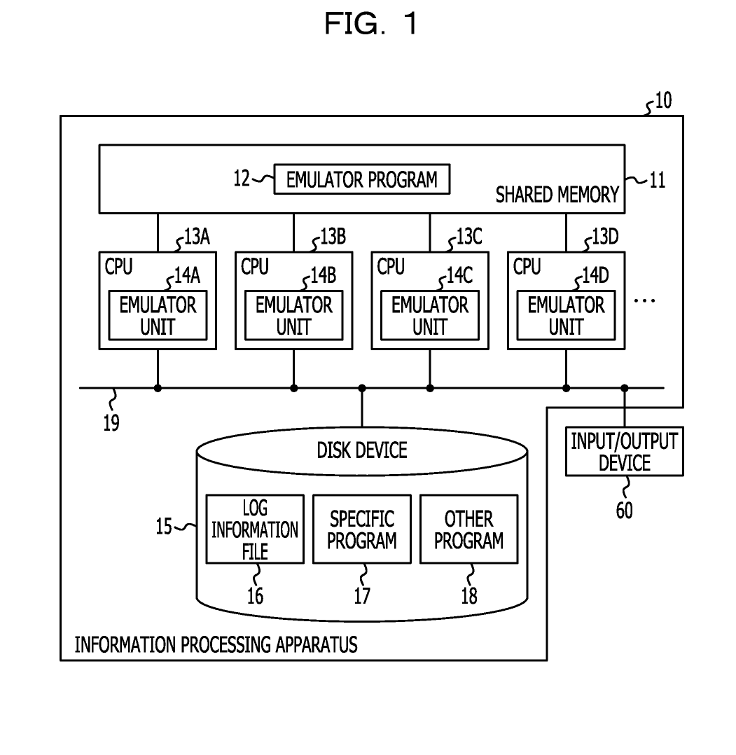

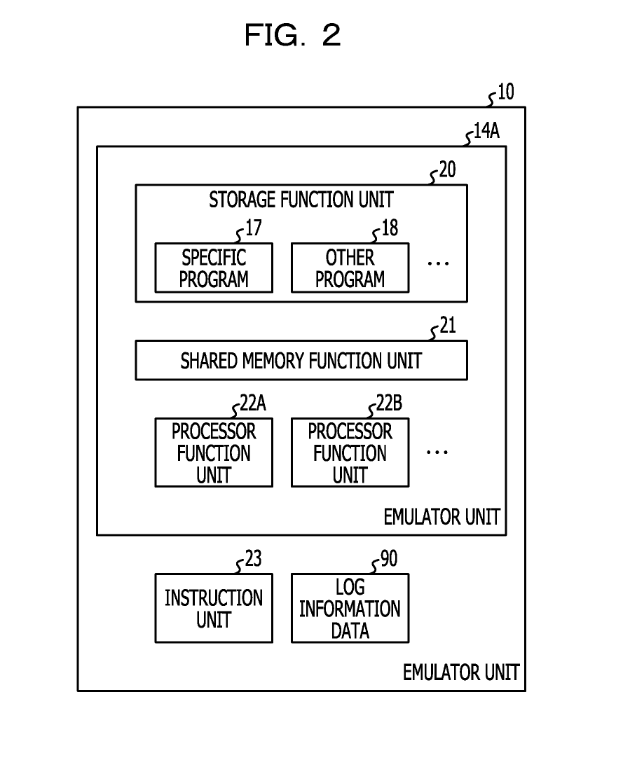

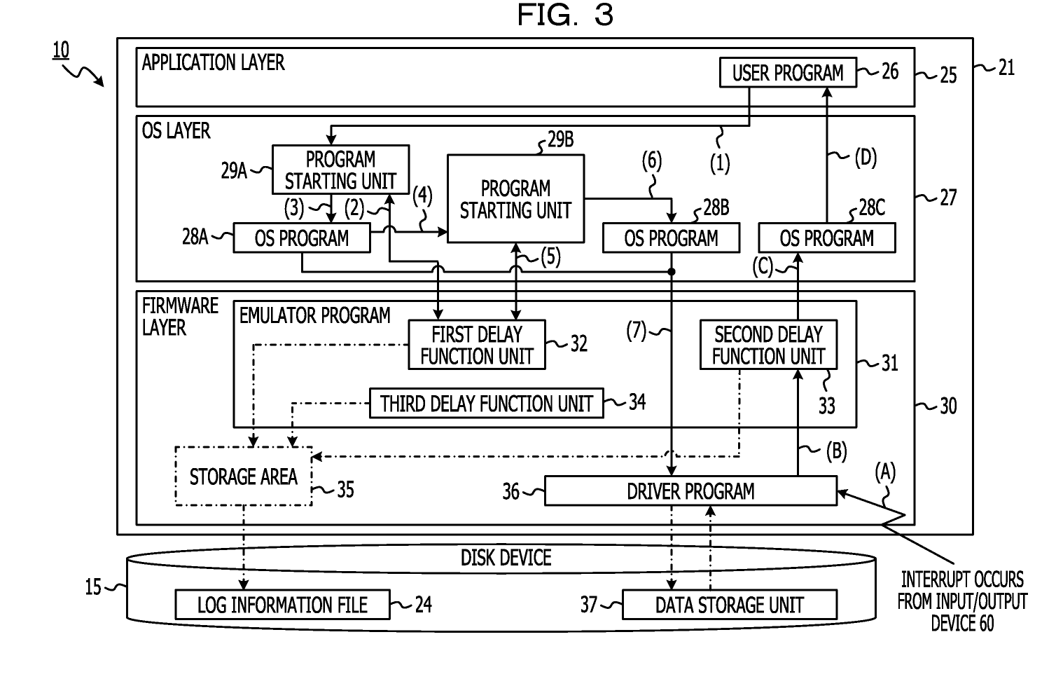

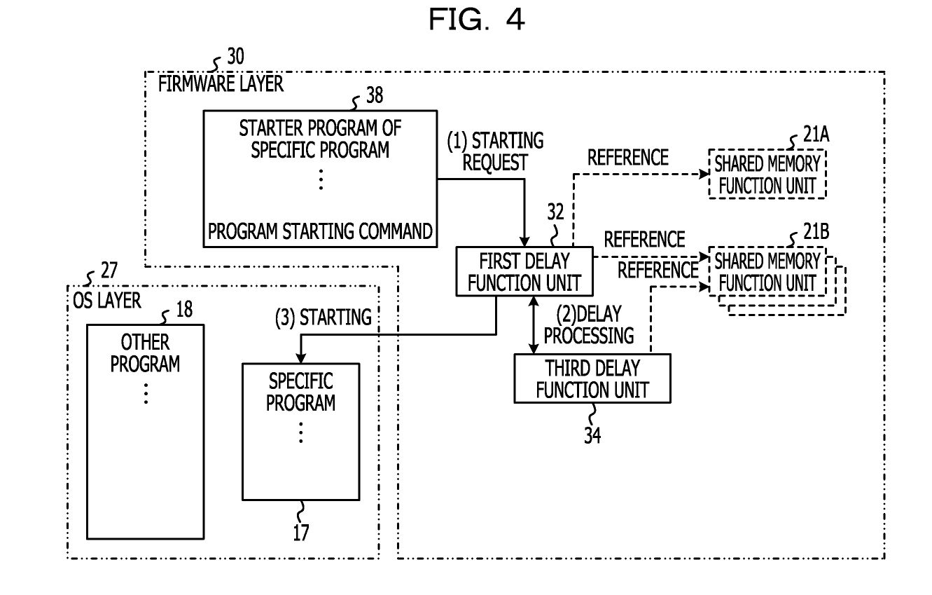

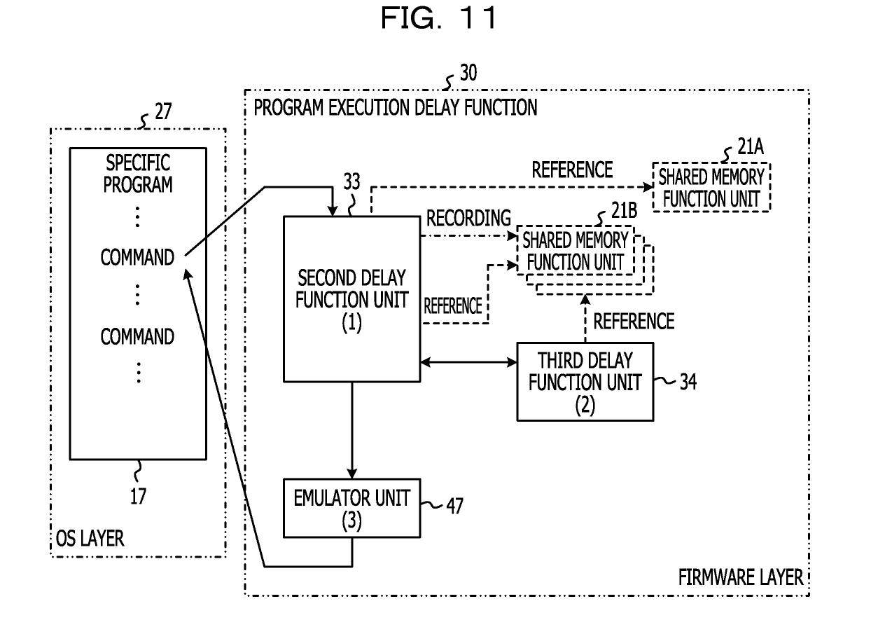

A first embodiment will describe the configuration of hardware, the configuration of software, program starting delay function, and program execution delay function. FIGS. 1 and 2 illustrate the configuration of hardware, FIG. 3 illustrates the configuration of software, FIGS. 4 to 10 illustrate the program starting delay function, and FIGS. 11 to 16 illustrate the program execution delay function.

FIG. 1 is a diagram illustrating a hardware configuration of an information processing apparatus 10 according to the first embodiment. The information processing apparatus 10 includes shared memory 11, a central processing unit (CPU) 13A, a CPU 13B, a CPU 13C, a CPU 13D, a disk device 15, and a bus 19.

The shared memory 11 is configured to store an OS program, an application program, and an emulator program, which the CPU 13A, CPU 13B, CPU 13C, and CPU 13D execute, and data to be used when the programs run.

An emulator program 12 is a program that emulates commands that the processors execute.

Each of the CPU 13A, CPU 13B, CPU 13C, and CPU 13D is connected with the shared memory 11 and disk device 15.

The CPU 13A will be described. Note that the CPU 13B, CPU 13C, and CPU 13D have the same configuration as with the CPU 13A, and accordingly, description will be omitted.

The CPU 13A is connected with the disk device 15 via the bus 19.

The CPU 13A includes an emulator unit 14A, and shares the shared memory 11 with the other CPU 13B, CPU 13C, and CPU 13D.

The CPU 13A controls the information processing apparatus 10 in cooperation with the other CPU 13B, CPU 13C, and CPU 13D.

The CPU 13A outputs processing result data and so forth to the disk device 15.

The emulator 14A is a mechanism included in each processor, and is configured to execute an emulator program stored in the shared memory 11.

The disk device 15 is configured to store an OS program, an application program, an emulator program, and data to be used when the programs run.

There are a specific program (program specified by an user of the information processing apparatus 10), and another program (program not specified by the user of the information processing apparatus 10) as the OS programs, and data to be stored includes a log information file and so forth.

An input/output device 60 is connected with the information processing apparatus 10 via the bus 19.

Examples of the input/output device 60 include a disk device, a tape device, and a printer device.

FIG. 2 is a diagram illustrating a function configuration within the information processing apparatus 10 according to the first embodiment. The components described with reference to FIG. 1 are denoted with the same reference numerals, and description will be omitted.

A storage function unit 20 stores programs such as a specific program 17, another program 18, and so forth.

A shared memory function unit 21 is configured to store various types of data used at the time of executing an OS program, an application program, an emulator program 12, or the like which are executed at processor function units 22A and 22B and so forth.

The processor function units 22A and 22B, and so forth are configured to execute the OS program, application program, emulator program 12, and so forth stored in the storage function unit 20.

An instruction unit 23 is configured to analyze instruction contents from the user of the information processing apparatus 10, and to store the instruction contents thereof in the shared memory function unit 21.

Log information data 90 is configured to store the status of another processor, sampled at the time of a specific program being started or executed, and so forth.

FIG. 3 is a diagram illustrating a software configuration of the information processing apparatus 10 according to the first embodiment. Note that in FIG. 3 the same configurations as the configurations described in FIGS. 1 and 2 will be denoted with the same reference numerals, and description will be omitted.

The shared memory function unit 21 includes an application layer 25, an OS layer 27, and a firmware layer 30.

The application layer 25 includes a user program 26. The user program 26 is various types of application program to be used by the user.

As illustrated in (1) in FIG. 3, in the case that the user program 26 requests a service of an OS program, a program starting unit 29A is interposed between the programs.

The OS layer 27 includes OS programs 28A, 28B, and 28C, program starting units 29A and 29B, and so forth.

In the case that, as illustrated in (1) in FIG. 3, a service of an OS program has been requested from the user program 26, the program starting unit 29A and a first delay function unit 32 are interposed, as illustrated in (2) and (3) in FIG. 3, between the programs to start the OS program 28A. As illustrated in (4), (5), and (6) in FIG. 3, in the case of starting the OS program 28B from the OS program 28A as well, the program starting unit 29A and first delay function unit 32 is interposed between the programs.

As illustrated in (6) and (7) in FIG. 3, access to the disk device 15 is performed via a driver program 36 of the firmware layer 30.

As illustrated in (A), (B), (C), and (D) in FIG. 3, an access result informed from the disk device 15 is informed to the user program 26 by interposing the driver program 36 and OS program 28C.

The firmware layer 30 includes an emulator program 31, a storage area 35, the driver program 36, and so forth.

The program starting delay function, program execution delay function, and interrupt delay function from the input/output device 60, according to the present technology are operated as the emulator program 31.

The program starting delay function is realized by the first delay function unit 32, the program execution delay function is realized by a third delay function unit 34, and the interrupt delay function from the input/output device 60 is realized by a second delay function unit 33.

The storage area 35 is an area configured to store information regarding a program being executed at the own processor and another processor when executing the program starting delay function, program execution delay function, and interrupt delay function from the input/output device 60.

The driver program 36 performs access to the devices such as the disk device 15 and so forth in response to a request from the user program 26, OS program 28A, or the like.

The disk device 15 includes a log information file 24, a data storage unit 37, and so forth. The log information file 24 is configured to store operation history information of each program sampled from the storage area 35. The data storage unit 37 is configured to store data that the user program 26 uses, and so forth.

FIG. 4 is a diagram illustrating a software configuration for realizing the program starting delay function of the information processing apparatus 10 according to the first embodiment.

FIG. 4 is a software configuration in the case that the specific program 17 has been started.

In FIG. 4, the same configurations as the configurations described in FIGS. 1 to 3 are denoted with the same reference numerals, and description will be omitted.

The first delay function unit 32 is started on the firmware layer 30 by a command for starting the specific program 17 being executed on the OS layer 27.

The first delay function unit 32 calls up, in the case of the program starting delay function being used, the third delay function unit 34, and after returned from the third delay function unit 34, starts the specific program 17. Specifically, processing is performed in the order of (1), (2), and (3).

In the case of the program starting delay function being not used, the first delay function unit 32 starts the specific program 17. Specifically, processing is performed in the order of (1) and (3).

(1) in FIG. 4 illustrates processing by the first delay function unit 32.

A starter program 38 executes a command for starting the specific program 17. According to execution of the starting command, the first delay function unit 32 is operated.

The first delay function unit 32 references information specified by the user of the information processing apparatus 10 stored in a shared memory function unit 21A to determine whether to delay starting of the specific program 17.

As illustrated in (3) in FIG. 4, in the case of delaying starting of the specific program 17, the first delay function unit 32 calls up the third delay function unit 34, waits for elapse of time at the third delay function unit 34. Thereafter, after returning from the third delay function unit 34, the first delay function unit 32 starts the specific program 17.

As illustrated in (3) in FIG. 4, in the case of not delaying starting of the specific program 17, the first delay function unit 32 starts the specific program 17. Note that information setting to the shared memory function unit 21A is processed at the instruction unit 23 in FIG. 2.

(2) in FIG. 4 illustrates processing by the third delay function unit 34.

In the case of being called up from the first delay function unit 32, the third delay function unit 34 waits for elapse of certain time, and after elapse of the time, returns to the first delay function unit 32.

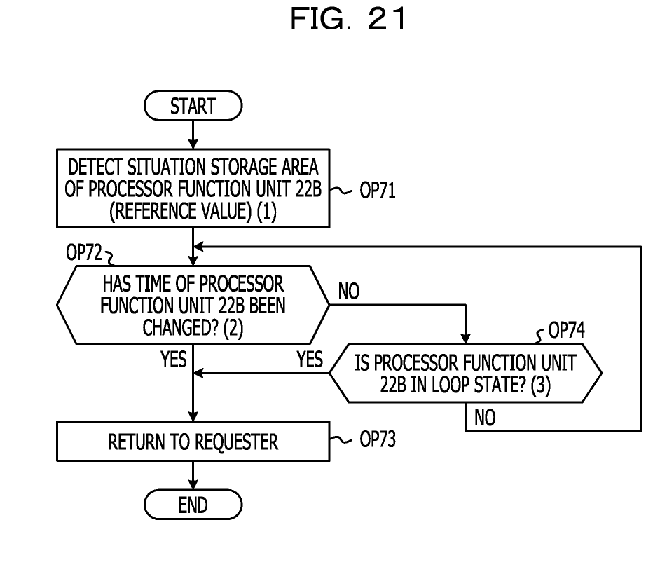

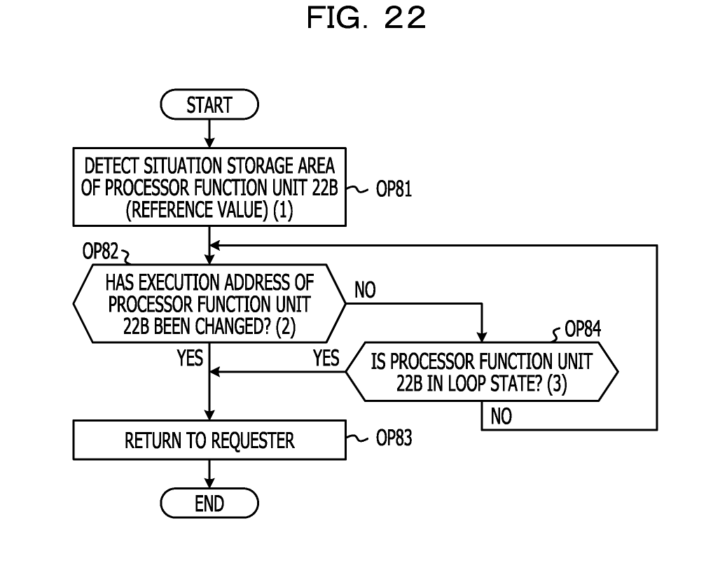

The third delay function unit 34 references information stored in a shared memory function unit 21B to recognize elapsed time. Details will be illustrated in FIGS. 21 and 22.

(3) in FIG. 4 illustrates starting processing of the specific program 17 by the first delay function unit 32.

In the case that the program starting delay function is not used, or in the case of returning from the third delay function unit 34, the first delay function unit 32 performs emulation of a command for starting the program.

Starting of the specific program 17 is delayed at the information processing apparatus 10 by the processing in (1) to (3) illustrated in FIG. 4, which enables the specific program 17 and the other program 18 to be run in parallel.

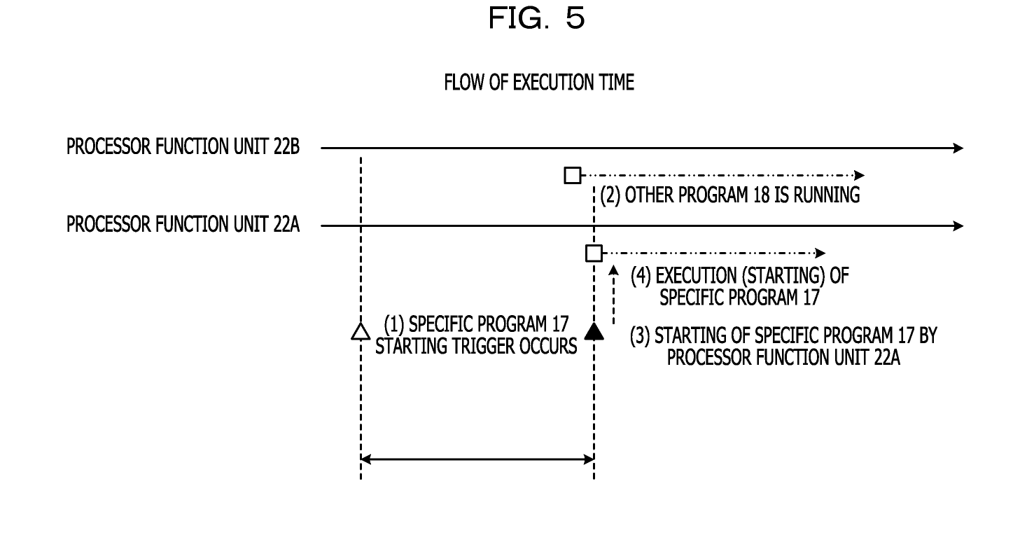

FIG. 5 is a diagram conceptually illustrating operation of the program starting delay function of the information processing apparatus 10 according to the first embodiment. Solid line arrows in the right direction in FIG. 5 illustrate flows of execution time of the processor function units 22A and 22B.

Note that FIG. 5 is illustrated assuming that the program starting delay function is used, the specific program 17 is started at the processor function unit 22A, and the other program 18 is started at the processor function unit 22B.

(1) in FIG. 5 illustrates a starting trigger occurrence for the specific program 17.

When starting request for the specific program 17 occurs at the processor function unit 22A of the information processing apparatus 10, the first delay function unit 32 determines whether or not the other program 18 is being executed at another processor function unit.

At the point-in-time in (1) in FIG. 5, the other program 18 is not executed, and consequently, the first delay function unit 32 delays starting of the specific program 17, and waits for the time to elapse.

(2) in FIG. 5 illustrates a starting trigger occurrence for the other program 18.

When starting request for the other program 18 occurs at the processor function unit 22B of the information processing apparatus 10, the other program 18 is started.

(3) in FIG. 5 illustrates a state in which time has elapsed after the starting trigger occurrence of the specific program 17.

When time elapses, the first delay function unit 32 is started at the processor function unit 22A. The first delay function unit 32 determines whether or not the other program 18 is being executed at the processor function unit 22B.

At the point-in-time in (3) in FIG. 5, the other program 18 is executed at the processor function unit 22B, so the first delay function unit 32 starts the specific program 17.

(4) in FIG. 5 illustrates execution of the specific program 17.

The first delay function unit 32 starts the specific program 17, whereby the specific program 17 is started at the processor function unit 22A.

The procedures of (1) to (4) in FIG. 5 enable the information processing apparatus 10 to operate the specific program 17 and other program 18 in parallel.

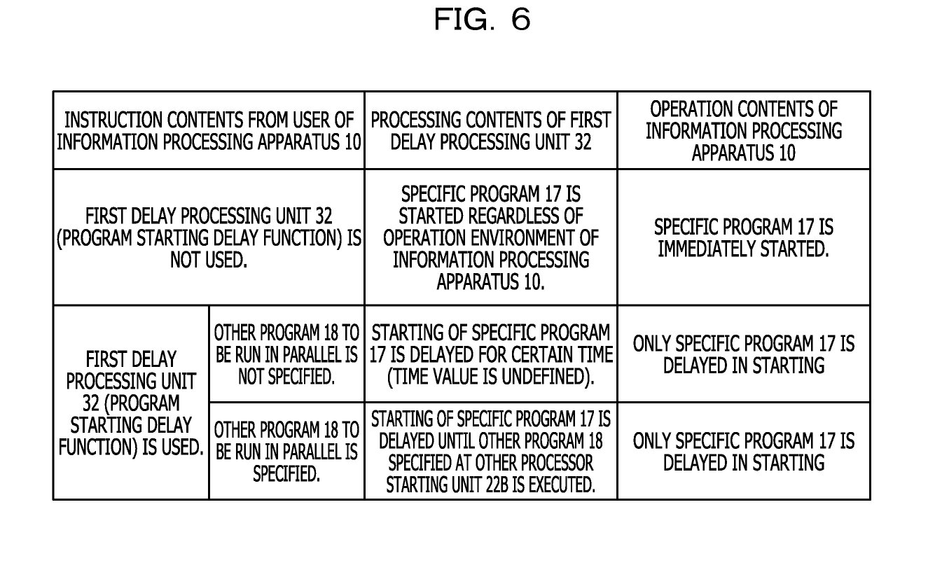

FIG. 6 is a table illustrating a relation between instruction contents regarding the program starting delay function from the user, and operation contents of the information processing apparatus 10.

In FIG. 6, the same configurations as the configurations described in FIGS. 1 to 5 are denoted with the same reference numerals, and description will be omitted.

In the case that the user of the information processing apparatus 10 does not use the program starting delay function (does not specify the specific program 17), starting of the program is not delayed.

In the case that the user of the information processing apparatus 10 uses the program starting delay function (specifies the specific program 17), and also a program to be run in parallel is not specified, starting of the specific program 17 is delayed for certain time (time value is undefined).

In the case that the user of the information processing apparatus 10 uses the program starting delay function (specifies the specific program 17), and a program to be run in parallel is specified, starting of the specific program 17 is delayed until the program to be run in parallel is executed.

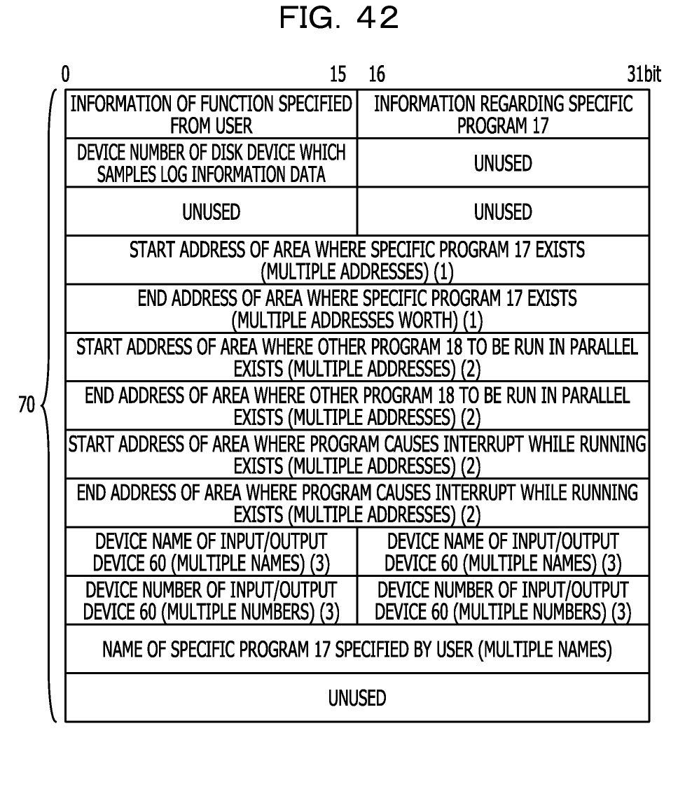

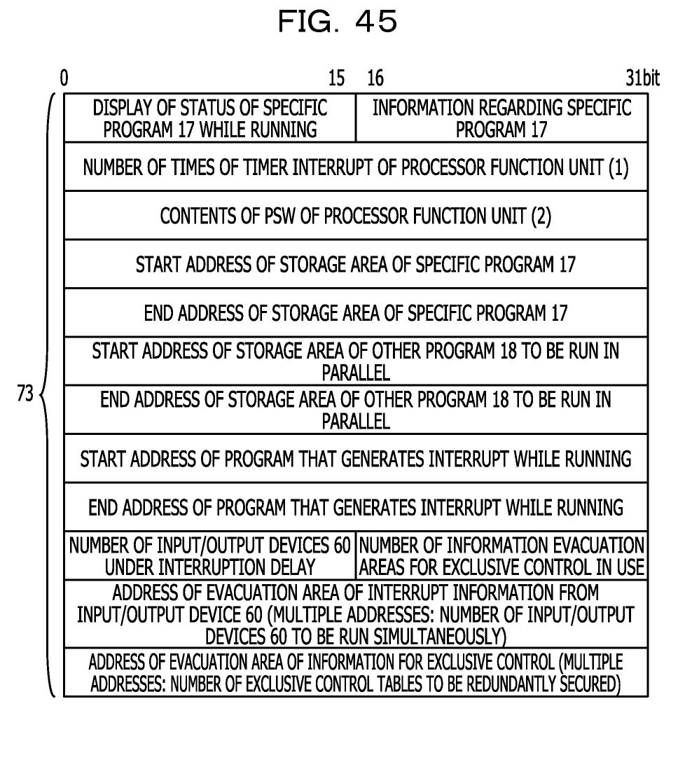

The above processing is performed with reference to the shared memory function units 21A and 21B. The contents of control tables to be referenced are illustrated in FIGS. 42 and 45.

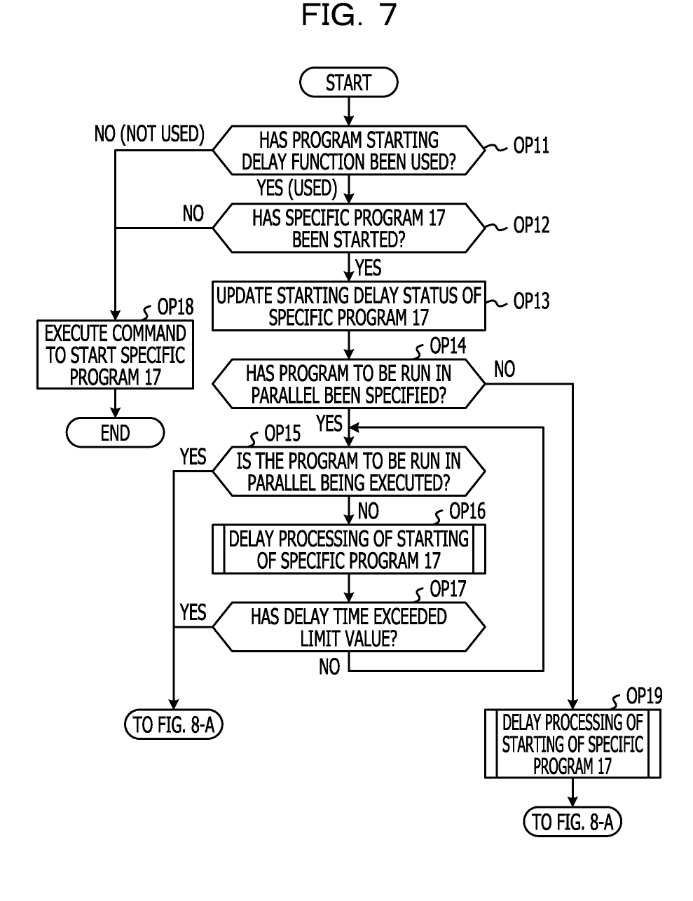

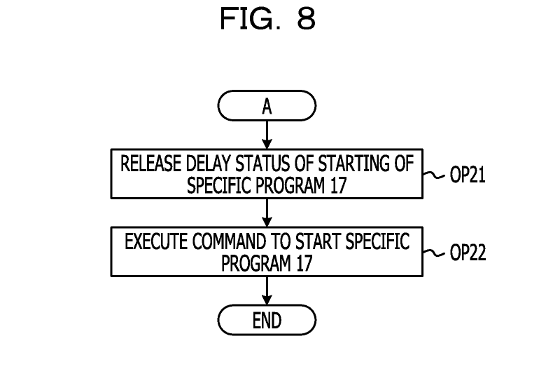

FIGS. 7 and 8 are flowcharts of the program starting delay function of the information processing apparatus 10. FIGS. 7 and 8 correspond to the first delay function unit 32 described in FIG. 2, and are described using the terms described in FIG. 2.

Note that, in order to facilitate understanding of description, description will be made assuming that the first delay function unit 32 operates at the processor function unit 22A.

The first delay function unit 32 determines whether or not use of the program starting delay function has been specified by the user of the information processing apparatus 10 (OP11).

In the case that use of the program starting delay function has not been specified (NO in OP11), the first delay function unit 32 starts the program without doing anything (OP18), and ends the processing.

In the case that use of the program starting delay function has been specified (YES in OP11), the first delay function unit 32 determines whether or not the program to be started is the designated specific program 17 (OP12).

In the case that the program to be started is not the designated specific program 17 (NO in OP12), the first delay function unit 32 starts the program without doing anything (OP18), and ends the processing.

In the case that the program to be started is the designated specific program 17 (YES in OP12), the first delay function unit 32 updates the status display of the specific program 17 which is being executed of the control table for the processor function unit 22A, stored in the shared memory function unit 21B (OP13).

The first delay function unit 32 determines whether or not a program to be run in parallel has been specified from the user of the information processing apparatus 10 (OP14).

In the case that the program to be run in parallel has not been specified (NO in OP14), the first delay function unit 32 calls up program starting delay processing, in order to wait for the time to elapse.

Upon returning from the program starting delay processing, the first delay function unit 32 performs processing in OP21.

In the case that the program to be run in parallel has been specified from the user (YES in OP14), the first delay function unit 32 determines whether the program to be run in parallel specified by the user is being executed (OP15).

In the case that the program to be run in parallel is being executed (YES in OP15), the first delay function unit 32 performs processing in OP21.

In the case that the program to be run in parallel, that has been specified, is not being executed (NO in OP15), the first delay function unit 32 calls up the program starting delay processing (OP16) in order to wait for the time to elapse.

Upon returning from the program starting delay processing, the first delay function unit 32 determines whether or not the delay time has exceeded a limit value (OP17).

In the case of having exceeded the limit value of the delay time (YES in OP17), the first delay function unit 32 performs processing in OP21.

In the case of not having exceeded the limit value of the delay time (NO in OP17), the first delay function unit 32 repeats from the processing in OP15.

The first delay function unit 32 updates the status display of the running specific program 17 of the control table for the processor function unit 22A, stored in the shared memory function unit 21B (OP21).

The first delay function unit 32 starts the specific program 17 (OP22), and ends the processing.

Note that the above processing is performed with reference to the shared memory function units 21A and 21B. The contents of control tables to be referenced are illustrated in FIGS. 42 and 45.

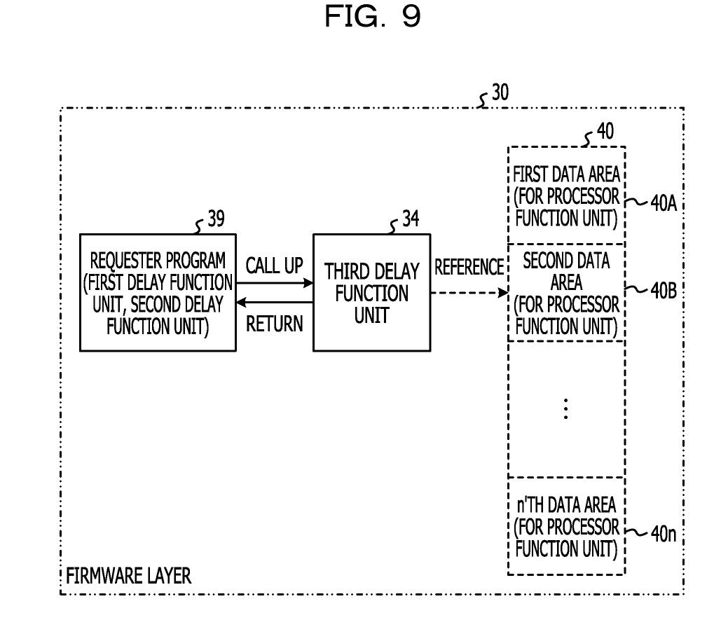

A relation between the first delay function unit 32 and the program starting delay processing is illustrated in FIG. 9.

Details of the program starting delay processing will be illustrated in FIGS. 21 and 22.

FIG. 9 is a diagram illustrating a relation between programs of delay function units according to the first embodiment.

The third delay function unit 34 is started by being called up from the first delay function unit 32 serving as the program starting delay function, or the second delay function unit 33 serving as the program execution delay function.

The third delay function unit 34 recognizes elapsed time based on change in the status of another processor function unit. The third delay function unit 34 determines change in the status of another processor function unit with reference to the control table of each processor function unit stored in the shared memory function unit 40.

Detailed processing contents will be illustrated in FIGS. 21 and 22.

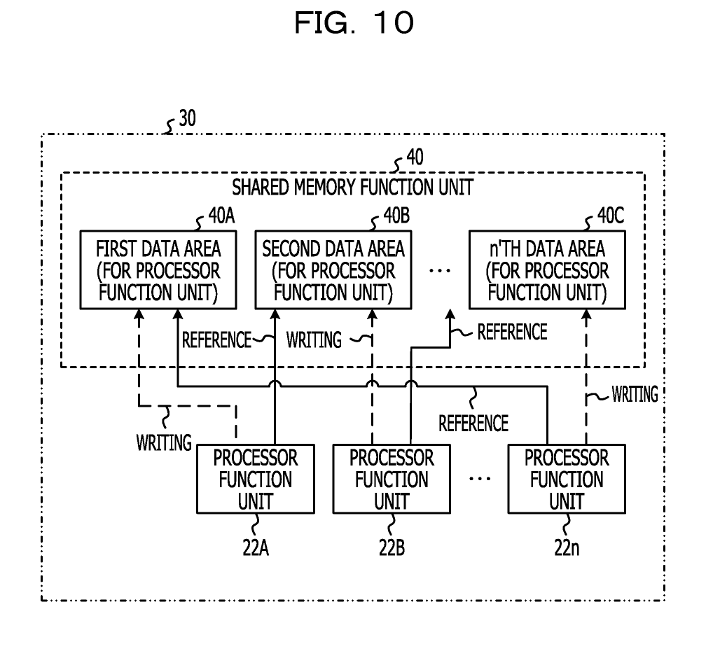

FIG. 10 is a diagram illustrating a relation between each processor function unit relating to control of the program execution delay function, and the control table (data area for processor function unit).

First data area (for processor function unit) to n′th data area (for processor function unit) are created corresponding to processor function units.

The processor function unit 22A corresponds to the first data area 40A, the processor function unit 22B corresponds to the second data area 40B, and the processor function unit 22n corresponds to the n′th data area 40n. Each of the processor function units stores operation status information in the corresponding n′th data area.

When referencing the status of another processor function unit, the processor function unit 22A is correlated with the second data area 40B, the processor function unit 22B is correlated with the third data area 40C, and the processor function unit 22n is correlated with the first data area 40A. Each of the processor function units references the corresponding n′th data area.

Note that the first data area (for processor function unit) to the n′th data area (for processor function unit) are created in the shared memory function unit 40.

FIG. 11 is a diagram illustrating a software configuration for realizing the execution speed delay processing of the specific program 17.

Upon the running specific program 17 executing a command on the OS layer 27, the second delay function unit 33 which operates on the firmware layer 30 is started.

The second delay function unit 33 determines whether to delay the execution speed of the specific program 17. In the case of delaying the execution speed, the second delay function unit 33 calls up the third delay function unit 34 in order to wait for the time to elapse.

Upon returning from the third delay function unit 34, the second delay function unit 33 hands the control to the emulator unit 47.

The processing is performed in the order of the second delay function unit 33, third delay function unit 34, and emulator unit 47.

In the case of not delaying the execution speed, the second delay function unit 33 hands the control to the emulator unit 47.

The processing is performed in the order of the second delay function unit 33, and emulator unit 47.

The emulator unit 47 performs emulation of a command executed by the specific program 17.

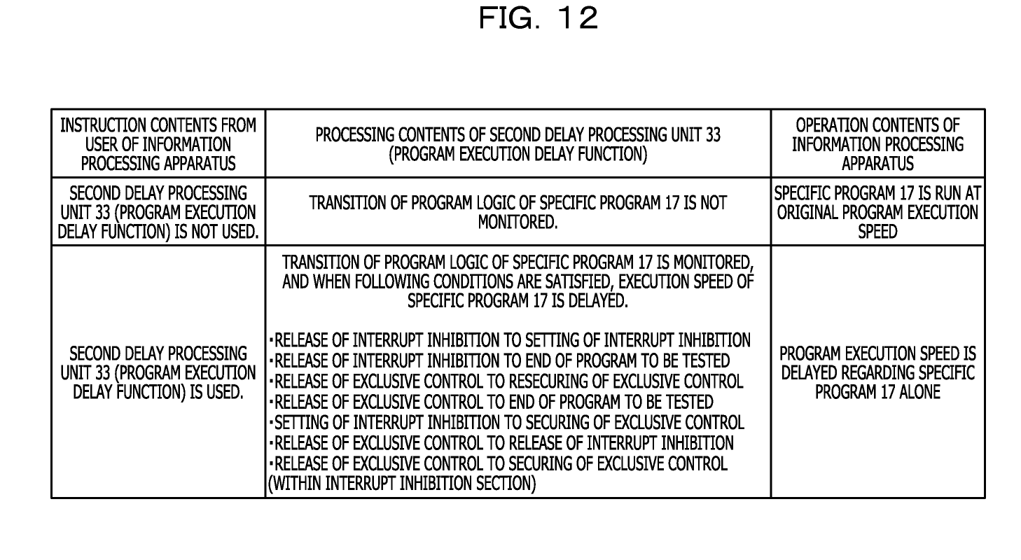

FIG. 12 is a diagram illustrating processing contents of the program execution delay function.

In the case that the user of the information processing apparatus 10 does not use the program execution delay function (does not use the second delay function unit 33), the execution speed of the program is not delayed.

In the case that the user of the information processing apparatus 10 uses the program execution delay function (uses the second delay function unit 33), when the specific program 17 is in one of predetermined states, the execution speed of the program is delayed. The predetermined states are a state from release of interrupt inhibition to setting of interrupt inhibition, a state from release of interrupt inhibition to end of a program to be tested, a state from release of exclusive control to resecuring of exclusive control, a state from release of exclusive control to end of a program to be tested, a state from setting of interrupt inhibition to securing of exclusive control, a state from release of exclusive control to release of interrupt inhibition, and a state from release of exclusive control to securing of exclusive control (within interrupt inhibition section).

The above processing is performed with reference to the shared memory function units 21A and 21B. The contents of control tables to be referenced will be illustrated in FIGS. 42 and 45.

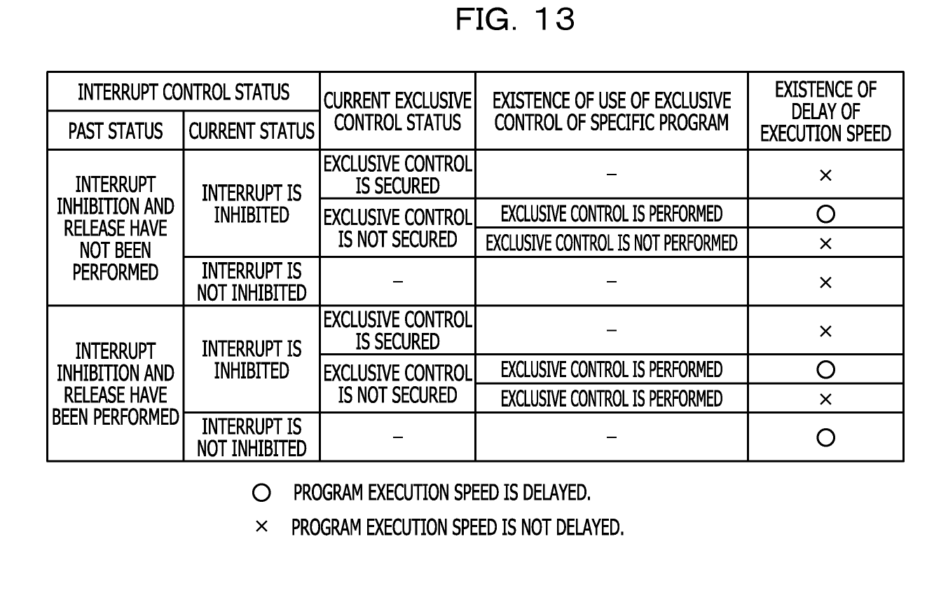

FIG. 13 is a table illustrating a relation between a status transition of interrupt inhibition and release of the specific program 17, and the execution speed delay processing of the specific program 17 in the program execution delay function.

When the specific program 17 makes the transition to one of predetermined states regarding interrupt inhibition and release of the specific program 17, the execution speed of the program is delayed. The predetermined states are a state from release of interrupt inhibition to setting of interrupt inhibition, a state from release of interrupt inhibition to end of a program to be tested, and a state from setting of interrupt inhibition to securing of exclusive control.

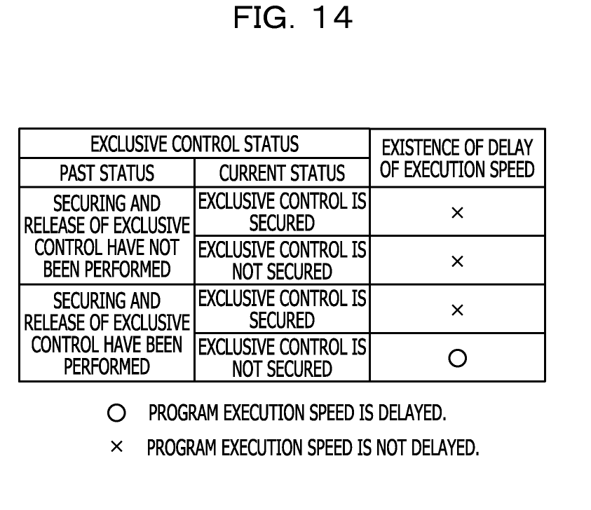

FIG. 14 is a table illustrating a relation between a status transition of securing and release of exclusive control, and the execution speed delay processing of the specific program 17 in the program execution delay function.

When the specific program 17 makes the transition to one of predetermined states regarding securing and release of exclusive control of the specific program 17, the execution speed of the program is delayed. The predetermined states are a state from release of exclusive control to resecuring of exclusive control, a state from release of exclusive control to end of a program to be tested, and a state from release of exclusive control to release of interrupt inhibition, and a state from release of exclusive control to securing of exclusive control (within interrupt inhibition section).

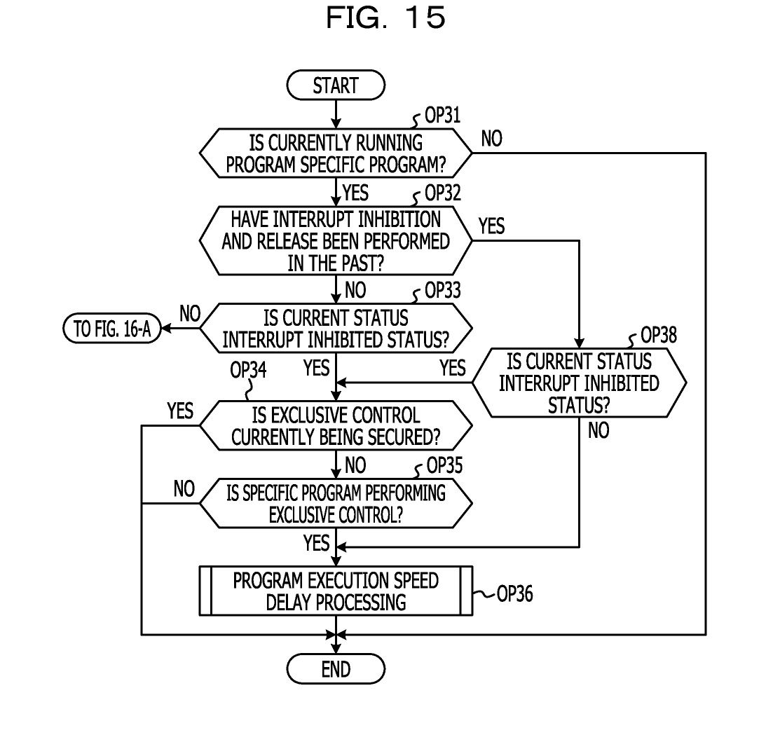

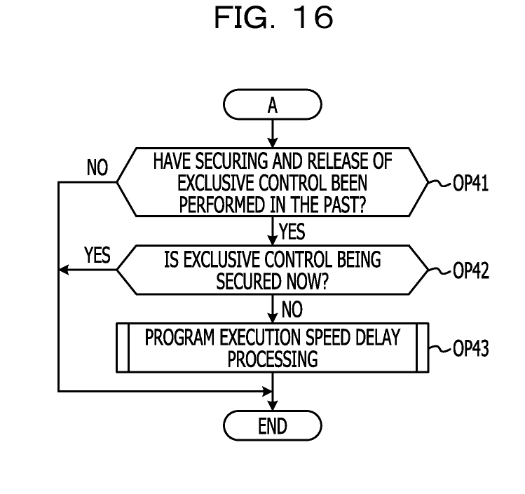

FIGS. 15 and 16 are flowcharts of processing for determining a range where the execution speed of a program is delayed, and are flowcharts of the processing contents of the second delay processing unit 33 described in FIG. 11.

Note that, in order to facilitate understanding of description, description will be made assuming that the user of the information processing apparatus 10 uses the program execution delay function.

The contents of control tables to be referenced in this processing will be illustrated in FIGS. 42 and 45.

The second delay function unit 33 checks whether or not the currently running program is the specific program 17 specified by the user (OP31).

In the case that the currently running program is not the designated specific program 17 (NO in OP31), the second delay function unit 33 ends the processing without doing anything. Thereafter, the emulator unit 47 is started to perform emulation of a command executed by the specific program 17.

In the case that the currently running program is the designated specific program 17 (YES in OP31), the second delay function unit 33 checks whether or not the specific program 17 has performed interrupt inhibition and release in the past (OP32).

In the case that the specific program 17 has performed interrupt inhibition and release in the past (YES in OP32), the second delay function unit 33 performs processing in OP38.

In the case that the specific program 17 has not performed interrupt inhibition and release in the past (NO in OP32), the second delay function unit 33 checks whether or not the specific program 17 performs interrupt inhibition now (OP33).

In the case that the specific program 17 is not currently performing interrupt inhibition (NO in OP33), the second delay function unit 33 performs processing in OP41.

In the case that the specific program 17 is currently performing interrupt inhibition (YES in OP33), the second delay function unit 33 checks whether or not the specific program 17 secures exclusive control now (OP34).

In the case of securing exclusive control (YES in OP34), the second delay function unit 33 ends the processing.

Thereafter, the emulator unit 47 is started to perform emulation of a command executed by the specific program 17.

In the case of not securing exclusive control (NO in OP34), the second delay function unit 33 checks whether or not the specific program 17 is a program which may possibly perform exclusive control (OP35).

In the case that the specific program 17 is a program having no possibility of performing exclusive control (NO in OP35), the second delay function unit 33 ends the processing.

Thereafter, the emulator unit 47 is started to perform emulation of a command executed by the specific program 17.

In the case that the specific program 17 is a program which may possibly perform exclusive control (YES in OP35), the second delay function unit 33 calls up the third delay function unit 34 (program execution speed delay processing), in order to wait for the time to elapse (OP36). Upon returning from the third delay function unit 34 (program execution speed delay processing), the second delay function unit 33 ends the processing.

Thereafter, the emulator unit 47 is started to perform emulation of a command executed by the specific program 17.

In the case that the specific program 17 has performed interrupt inhibition and release in the past (YES in OP32), the second delay function unit 33 checks whether or not the specific program 17 is performing interrupt inhibition now (OP38).

In the case that the specific program 17 is not performing interrupt inhibition (NO in OP38), the second delay function unit 33 performs processing in OP36.

In the case that the specific program 17 is performing interrupt inhibition (YES in OP38), the second delay function unit 33 performs processing in OP34.

The second delay function unit 33 checks whether or not the specific program 17 has performed securing and release of exclusive control in the past (OP41).

In the case that the specific program 17 has not performed securing and release of exclusive control (NO in OP41), the second delay function unit 33 ends the processing.

Thereafter, the emulator unit 47 is started to perform emulation of a command executed by the specific program 17.

In the case that the specific program 17 has performed securing and release of exclusive control (YES in OP41), the second delay function unit 33 checks whether or not the specific program 17 is performing securing of exclusive control now (OP42).

In the case that the specific program 17 is performing securing of exclusive control (YES in OP42), the second delay function unit 33 ends the processing.

Thereafter, the emulator unit 47 is started to perform emulation of a command executed by the specific program 17.

In the case that the specific program 17 is not performing securing of exclusive control (NO in OP42), the second delay function unit 33 calls up the third delay function unit 34 (program execution speed delay processing), in order to wait for the time to elapse (OP43). Upon returning from the third delay function unit 34 (delay processing of program execution speed), the second delay function unit 33 ends the processing.

Thereafter, the emulator unit 47 is started to perform emulation of a command executed by the specific program 17.

The program starting delay function by the specific program 17 of the information processing apparatus 10 according to the first embodiment enables starting or execution of the specific program 17 to be intentionally delayed by the first delay function unit 32 (program starting delay function), second delay function unit 33 (program execution delay function), and third delay function unit 34.

This function enables the specific program 17 and other program 18 to be run in parallel, which facilitates occurrence of a program error such as interrupt control, exclusive control, and so forth to be exposed in the case that two or more programs run in parallel.

Implementing a test in such a system environment facilitates detection of an underlying program error of a program to be tested.

### Second Embodiment

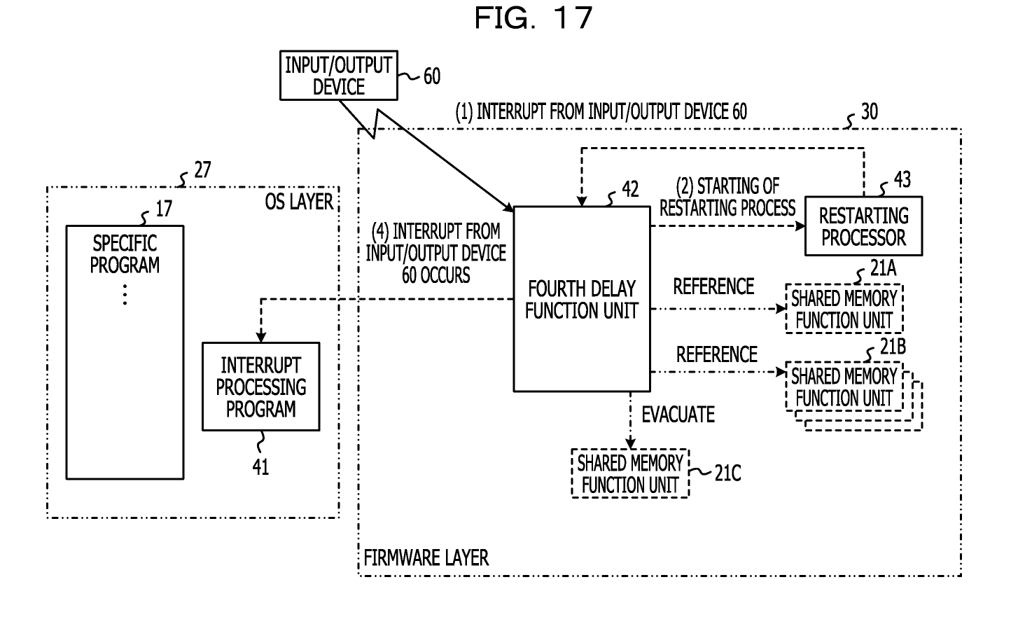

A second embodiment will describe an interrupt delay function from the input/output device 60 in the information processing apparatus 10, with reference to FIGS. 17 to 25.

Note that the second delay function unit 33 and fourth delay function unit 42 described in FIG. 3 have the same function.

An interrupt delay function from the input/output device 60 may also be employed, in the case that load to the designated input/output device 60 or input/output device 60 having the designated device type increases, when investigating phenomena that occur on the information processing apparatus 10.

FIG. 17 is a diagram illustrating a software configuration for realizing the interrupt delay function at the information processing apparatus 10.

In FIG. 17, description will be omitted regarding those described in FIGS. 1 to 16.

Note that the contents of control tables to be referenced and updated with the interrupt delay function from the input/output device 60 will be illustrated in FIGS. 42 and 45.

The specific program 17 and an interrupt processing program 41 run on the OS layer 27.

The fourth delay function unit 42 and a restarting processor 43 run on the firmware layer 30.

(1) in FIG. 17 illustrates interrupt processing from the input/output device 60.

Upon an interrupt from the input/output device 60 occurring, the fourth delay function unit 42 is started.

The fourth delay function unit 42 determines whether to delay the interrupt from the input/output device 60.

In the case of not delaying the interrupt, an interrupt from the input/output device 60 is generated. (4) in FIG. 17 illustrates generating of the interrupt by the input/output device 60. According to this interrupt, the interrupt processing program 41 is started.

The above processing is performed in the order of (1) and (4).

(2) in FIG. 17 illustrates starting processing of a restarting process.

In the case of delaying the interrupt, the fourth delay function unit 42 starts the restarting processor 43, in order to wait for the time to elapse.

(3) in FIG. 17 illustrates restarting processing of the restarting processor 43. Restarting from the restarting processor 43 causes the fourth delay function unit 42 to generate the interrupt from the input/output device 60. This interrupt starts the interrupt processing program 41.

That is to say, the above processing is performed in the order of (1), (2), (3), and (4).

The restarting processor 43 waits for the time to elapse, and after elapse of the time, starts the fourth delay function unit 42 again.

According to the processing in (1) to (4) in FIG. 17, the information processing apparatus 10 enables the interrupt by the input/output device 60 to be delayed.

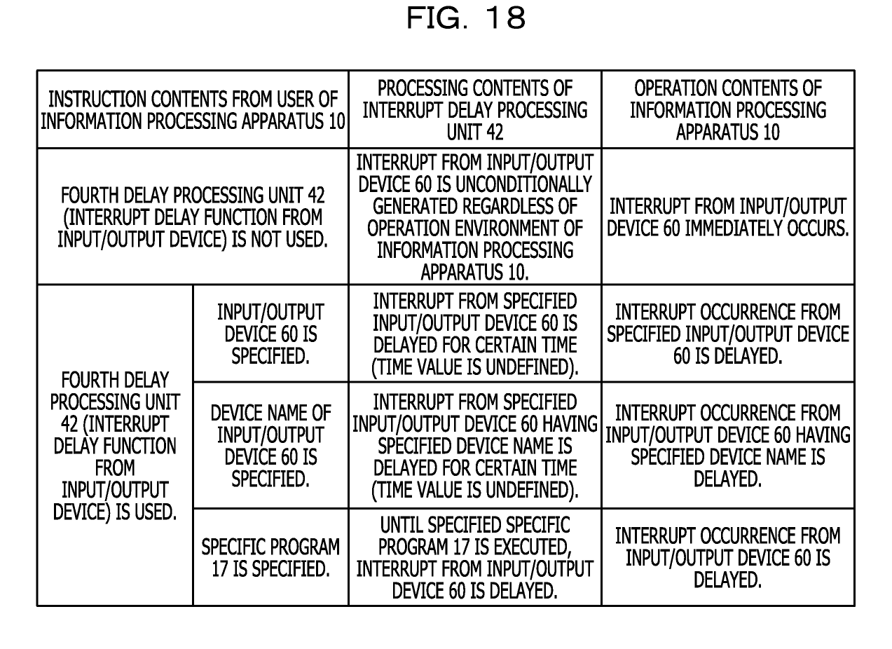

FIG. 18 is a table illustrating a relation between instruction contents from the user and processing contents of the interrupt delay function from the input/output device 60.

Note that description will be omitted in FIG. 18 regarding those described in FIG. 17.

In the case that use of the interrupt delay function from the input/output device 60 has not been instructed from the user of the information processing apparatus 10, the information processing apparatus 10 does nothing (does not delay the interrupt from the input/output device 60).

In the case that use of the interrupt delay function from the input/output device 60 has been instructed from the user of the information processing apparatus 10, and also in the case that the input/output device 60 has been specified, the interrupt from the specified input/output device 60 is delayed.

In the case that use of the interrupt delay function from the input/output device 60 has been instructed from the user of the information processing apparatus 10, and also the device name of the input/output device 60 has been specified, the interrupt from the input/output device 60 having the specified device name is delayed.

In the case that use of the interrupt delay function from the input/output device 60 has been instructed from the user of the information processing apparatus 10, and also the input/output device 60 or the device name has been specified, and further a program for generating an interrupt during running has been specified, the interrupt from the specified input/output device 60 or the input/output device 60 having the specified device name is delayed until the specified program is executed.

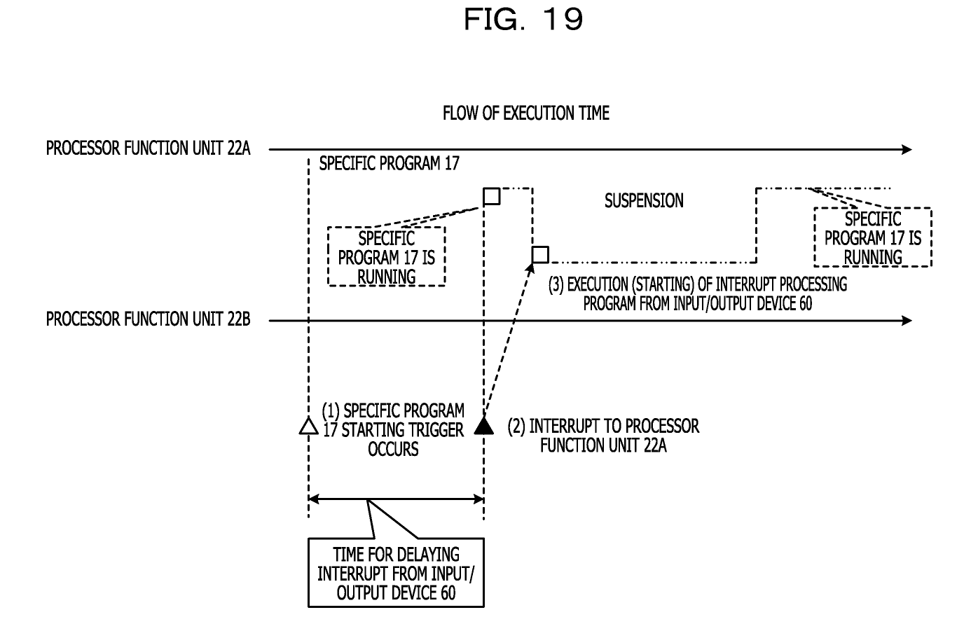

FIG. 19 is a diagram conceptually illustrating operation of the interrupt delay function from the input/output device 60 according to the second embodiment. The conceptual operation of the interrupt delay function of the input/output device 60 will be described.

In order to facilitate understanding of description, description will be made assuming that the interrupt from the input/output device 60 works on the processor function unit 22B, and the specific program 17 works on the processor function unit 22A.

Solid line arrows in the right direction in FIG. 19 illustrate flows of execution time of the processor function units 22A and 22B.

(1) in FIG. 19 illustrates occurrence of the interrupt from the input/output device 60.

The interrupt from the input/output device 60 occurs on the processor function unit 22B, and the fourth delay function unit 42 (the interrupt delay function from the input/output device 60) is started.

At this point-in-time, there is no program running on another processor function unit (processor function unit 22A), so in order to delay the interrupt from the input/output device 60, the fourth delay function unit 42 waits for elapse of delay time (predetermined time).

Thereafter, the starting request of the specific program 17 occurs on another processor function unit (processor function unit 22A), and the specific program 17 is started.

(2) in FIG. 19 illustrates a state in which the delay time (predetermined time) has elapsed.

Upon elapse of the delay time, the fourth delay function unit 42 is started again. At this point-in-time, the specific program 17 is being executed on another processor function unit (processor function unit 22A), so the fourth delay function unit 42 generates the interrupt from the input/output device 60.

(3) in FIG. 19 illustrates occurrence of the interrupt from the input/output device 60.

Upon the interrupt from the input/output device 60 occurring on the processor function unit 22A, the processor function unit 22A temporarily stops the processing of the specific program 17, and executes the interrupt processing program from the input/output device 60. After the interrupt processing program is ended, the processing of the specific program 17 is resumed.

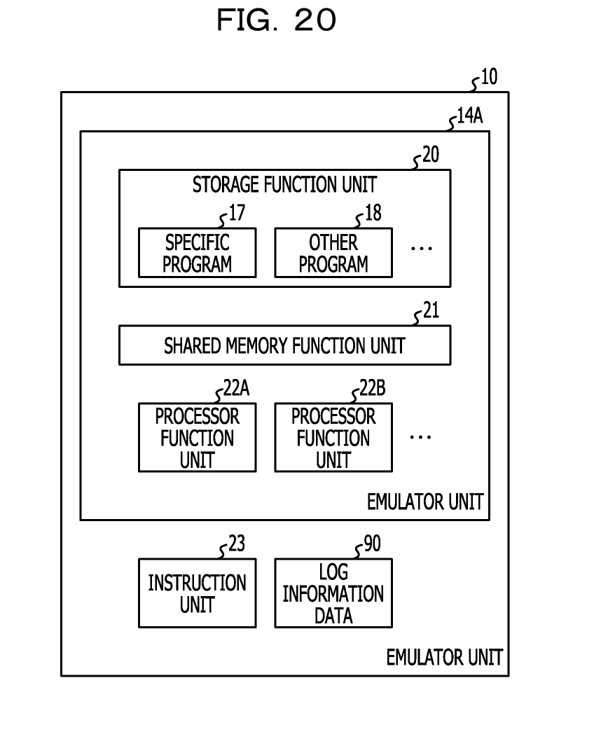

FIG. 20 is a diagram illustrating a function configuration within the information processing apparatus 10 according to the second embodiment. The information processing apparatus 10 according to the second embodiment has the same components as those described in FIG. 2, so description will be omitted.

FIGS. 21 and 22 are flowcharts of the program execution speed delay processing.

Description will be made regarding the program execution speed delay processing that the program starting delay function and program execution delay function use.

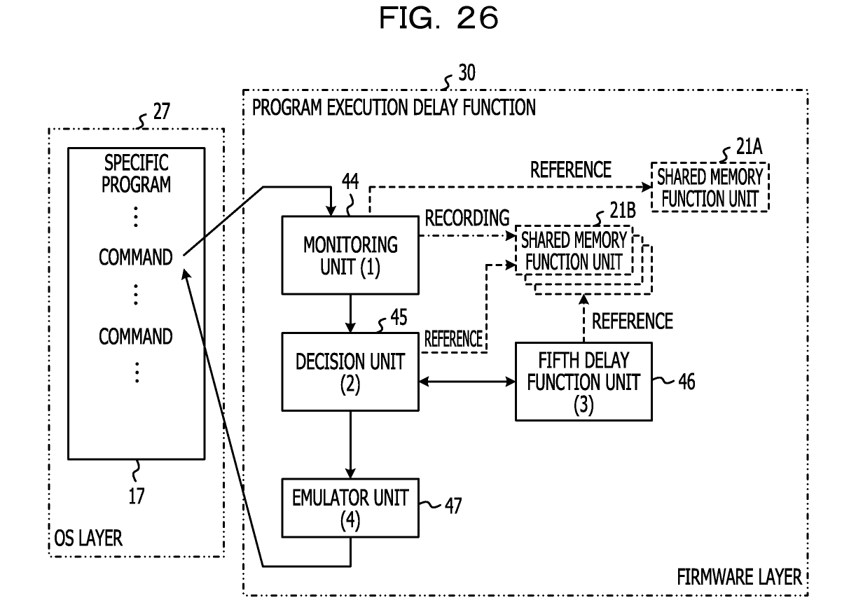

The program execution speed delay function is called up from the program starting delay function, which is the first delay function unit (see FIG. 4), or program execution delay function, which is the second delay function unit (illustrated in the decision unit in FIG. 26).

In order to facilitate understanding of description, description will be made assuming that the present processing operates on the processor function unit 22A.

Description will be made using the terms described in FIG. 11.

FIG. 21 is a method with timer interrupt from hardware (CPU).

The third delay function unit 34 detects the number of times of time (clock) interrupts of the processor function unit 22B at the time of this processing being started (OP71).

The third delay function unit 34 references the number of times of timer interrupts stored in the shared memory function unit 40 by the processor function unit 22B, as the number of times of timer interrupts of the processor function unit 22B.

In order to determine whether or not the time of the processor function unit 22B has elapsed for certain time, the third delay function unit 34 detects the number of times of timer interrupts of the processor function unit 22B at the current point-in-time (OP72). In the case that difference between the number of times of timer interrupts detected at the current point-in-time and the number of times of timer interrupts detected at the point-in-time of OP71 is equal to or greater than a certain number, the third delay function unit 34 determines that the certain time has elapsed (OP72).

In the case that the elapsed time is equal to or greater than the certain time (YES in OP72), the fourth delay function unit 42 returns to the requester (OP73).

In the case that the elapsed time is less than the certain time (NO in OP72), the fourth delay function unit 42 determines whether or not the processor function unit 22B is in a loop state (OP74).

In the case that the processor function unit 22B is in a loop state (YES in OP74), the fourth delay function unit 42 returns to the requester (OP73).

In the case that the processor function unit 22B is not in a loop state (NO in OP74), the fourth delay function unit 42 repeats from the processing in OP72.

The processing in OP74 is processing for suppressing the present processing from going into the same loop in the case that the referenced processor function unit 22B is in a loop state.

Note that the processor function unit to be referenced is a processor function unit having a CPU number obtained by adding 1 to or subtracting 1 from the CPU number of the processor function unit 22A, or a processor function unit having a CPU number n.

FIG. 22 is a method for a processing function unit using a running command address.

The third delay function unit 34 detects a running command address of another processor function unit (processor function unit 22B) at the point-in-time of starting this processing (OP81).

Let us say that the running command address is a running command address that another processor function unit has stored in the shared memory function unit 40.

The third delay function unit 34 detects the running command address of another processor function unit when the third delay function unit 34 executed the present processing (OP82).

The third delay function unit 34 determines whether or not difference between the running command address of another processor function unit detected in the present processing (OP82) and the running command address of another function unit detected in the processing in OP81 is equal to or greater than a certain number.

In the case that the difference between the running command addresses is equal to or greater than a certain number (YES in OP82), the third delay function unit 34 determines that the certain time has elapsed, and returns to the requester program (OP83).

In the case that the difference between the running command addresses is less than a certain number (NO in OP82), the third delay function unit 34 determines that the certain time has not elapsed, and determines whether or not another processor function unit is in a loop state (OP84).

In the case that another processor function unit is in a loop state (YES in OP84), the third delay function unit 34 determines that the certain time has elapsed, and returns to the requester program (OP83).

In the case that another processor function unit is not in a loop state (NO in OP84), the third delay function unit 34 repeats the present processing from the processing in OP82.

Note that determination whether or not another processor function unit is in a loop state is made by checking the states other than the processor function unit 22B, or by counting the number of times of loops of the present processing.

The processing in OP84 is processing for suppressing the present processing from going into a loop state in the case that another processor function unit goes into a loop state.

Another processor function unit is a processor function unit having a CPU number obtained by adding 1 to or subtracting 1 from the CPU number of the own processor function unit (processor function unit 22A in the present example), or a processor function unit having a CPU number n.

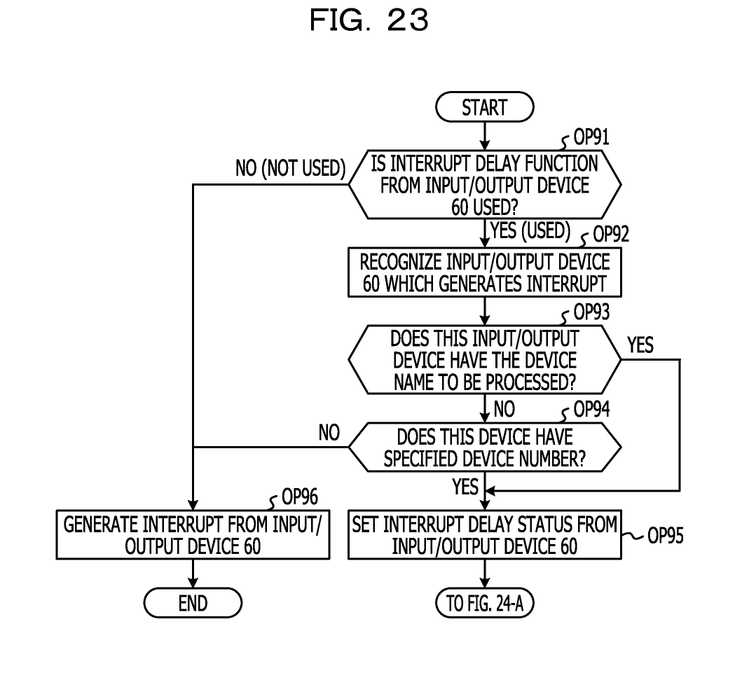

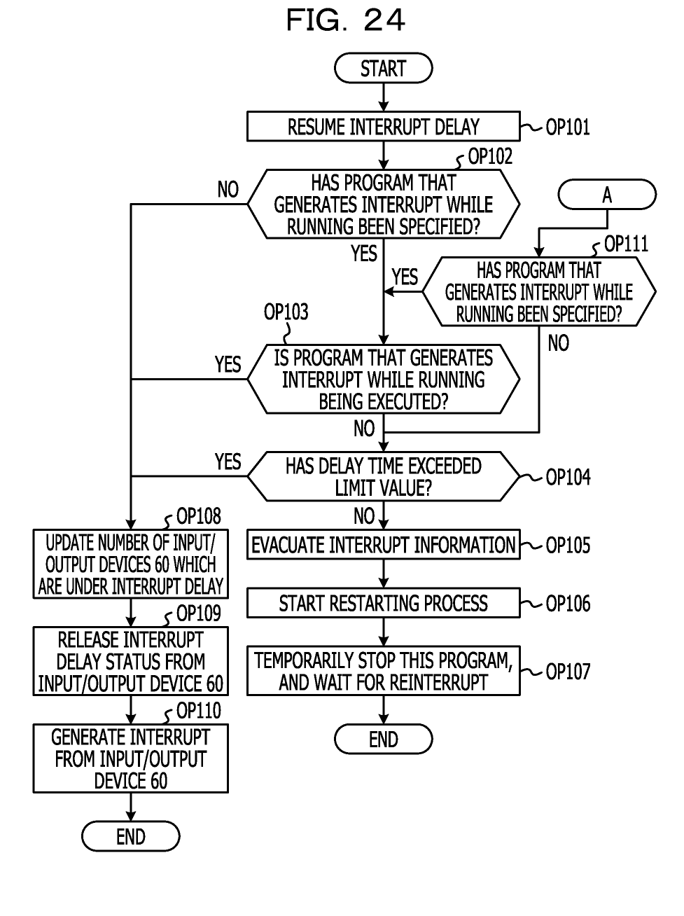

FIGS. 23 and 24 are flowcharts of the interrupt delay function from the input/output device 60 (fourth delay function unit 42).

FIG. 17 illustrates a configuration between programs relating to FIGS. 23 and 24.

The fourth delay function unit 42 described in FIG. 17 (the interrupt delay function from the input/output device 60) determines whether or not the user of the information processing apparatus 10 uses the interrupt delay function from the input/output device 60 (OP91).

In the case that the interrupt delay function from the input/output device 60 is not used (NO in OP91), the fourth delay function unit 42 generates an interrupt from the input/output device 60 (OP96).

In the case that the interrupt delay function from the input/output device 60 is used (YES in OP91), the fourth delay function unit 42 recognizes the input/output device 60 from which an interrupt has occurred (OP92).

Note that interrupt information informed from the input/output device 60 includes the device number of the input/output device 60.

The fourth delay function unit 42 compares the type of the input/output device 60 from which the interrupt has occurred with the type of the input/output device 60 specified by the user of the information processing apparatus 10 (OP93).

In the case that the types of the input/output devices are equal (YES in OP93), the fourth delay function unit 42 performs processing in OP95.

In the case that the types of the input/output devices 60 differ (NO in OP93), the fourth delay function unit 42 compares the device number of the input/output device 60 from which the interrupt has occurred with the device number of the input/output device 60 specified by the user of the information processing apparatus 10 (OP94).

In the case that the device numbers of the input/output devices 60 differ (NO in OP94), the fourth delay function unit 42 generates an interrupt from the input/output device 60 (OP96).

In the case that the types of the input/output devices 60 are equal (YES in OP93), or in the case that the device numbers of the input/output devices 60 are equal (YES in OP94), the fourth delay function unit 42 stores the interrupt information from the input/output device 60 (OP95).

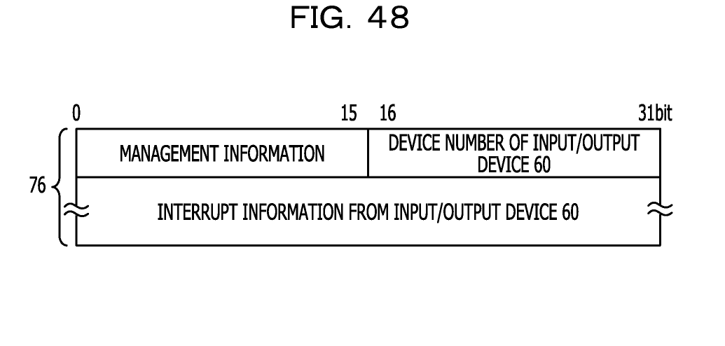

FIG. 48 illustrates a table in which the interrupt information from the input/output device 60 is stored.

The fourth delay function unit 42 determines whether or not a program that generates an interrupt from the input/output device 60 during running has been specified by the user of the information processing apparatus 10 (OP111).

In the case that a program that generates an interrupt from the input/output device 60 during running has been specified (YES in OP111), the fourth delay function unit 42 performs processing in OP103.

In the case that a program that generates an interrupt from the input/output device 60 during running has not been specified (NO in OP111), the fourth delay function unit 42 performs processing in OP104.

The processing in OP101 is started by restarting of the restarting processor 43. The fourth delay function unit 42 restores the interrupt information from the input/output device 60 stored in the processing in OP105 (OP101).

The fourth delay function unit 42 determines whether or not a program that generates an interrupt from the input/output device 60 during running has been specified by the user of the information processing apparatus 10 (OP102).

In the case that a program that generates an interrupt from the input/output device 60 during running has not been specified (NO in OP102), the fourth delay function unit 42 performs processing in OP108.

In the case that a program that generates an interrupt from the input/output device 60 during running has been specified (YES in OP111) or (YES in OP102), the fourth delay function unit 42 determines whether or not the specific program 17 specified by the user of the information processing apparatus 10 is being executed (OP103).

In the case that the specific program 17 is being executed (YES in OP103), the fourth delay function unit 42 performs processing in OP108.

In the case that the specific program 17 is not being executed (NO in OP103), the fourth delay function unit 42 determines whether or not the interrupt delay time of the input/output device 60 has exceeded a limit value (OP104).

In the case that the interrupt delay time of the input/output device 60 has exceeded a limit value (YES in OP104), the fourth delay function unit 42 performs the processing in OP102.

The processing in OP104 is for suppressing the following trouble phenomenon.

A case may also be conceived where the specific program 17 has not run for a long period of time due to a system operating environment.

In the case that the specific program 17 has not run for a long time, delay in the interrupt from the input/output device 60 for a long time may be recognized as a hardware failure of the input/output device 60.

Note that examples of a method for determining whether or not the interrupt delay time has exceeded a limited value include a method for determining this using time used for the present processing, and a method for determining this using the number of times of loops of the present processing.

In the case that the interrupt delay time has not exceeded a limit value (NO in OP104), the fourth delay function unit 42 stores the interrupt information from the input/output device 60 in a table described in FIG. 48 (third table 76) (OP105), and turns on the delay state of the interrupt from the input/output device 60 of the state display of the running specific program 17.

In order to wait for elapse of the delay time, the fourth delay function unit 42 starts the restarting processor 43 (OP106).

The fourth delay function unit 42 ends the processing (OP107).

The fourth delay function unit 42 waits for restarting from the restarting processor 43. When restarting is performed from the restarting processor 43, the fourth delay function unit 42 resumes from the processing in OP101.

The processing in OP108 is performed in any one of a case where a program that generates an interrupt from the input/output device 60 while running has not been specified by the user of the information processing apparatus 10 (NO in OP102), a case where a program that generates an interrupt from the input/output device 60 while running is being executed (YES in OP103), and a case where the interrupt delay time of the input/output device 60 has exceeded a limit value (YES in OP104).

The fourth delay function unit 42 has completed the interrupt delay processing, and accordingly decrements by one the number of the input/output devices 60 of which the interrupts are being delayed.

In the case that the number of the input/output devices 60 of which the interrupts are being delayed has reached 0, the fourth delay function unit 42 turns off the delay state of the interrupt from the input/output device 60 of the state display of the running specific program 17.

The fourth delay function unit 42 generates an interrupt from the input/output device 60 (OP110).

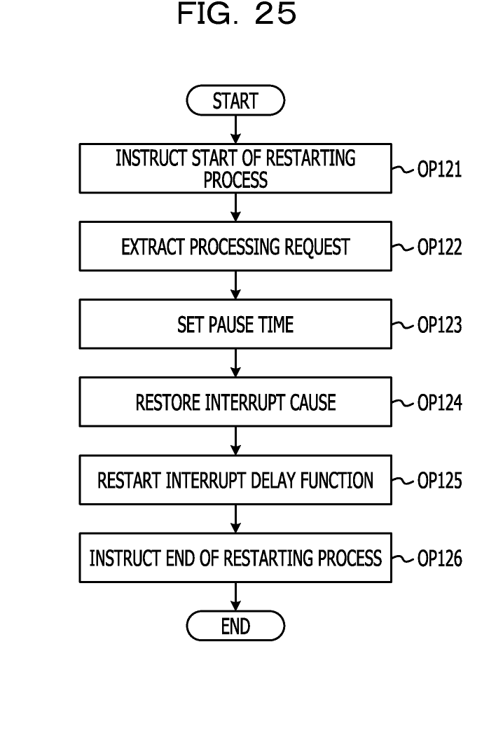

FIG. 25 is a flowchart of the restarting processor 43.

The restarting process (restarting processor 43) of the interrupt delay function from the input/output device 60 will be described. FIG. 17 illustrates a configuration between programs relating to FIG. 25.

The restarting processor 43 is started from the fourth delay function unit 42, and is configured to perform securing of a work area, initialization processing, and so forth (OP121).

The restarting processor 43 extracts request contents from the fourth delay function unit 42 (OP122).

The restarting processor 43 takes pause time in accordance with the extracted request contents (OP123). Upon the pause time having elapsed, the restarting processor 43 is restarted.

Note that examples of a method for waiting for elapse of time include a method using time difference caused from the execution priority of a process (time from occurrence of starting request until starting), and a method using an elapsed time informing function provided from an OS.

The restarting processor 43 generates information to be informed to the fourth delay function unit 42 (OP124).

The restarting processor 43 restarts the fourth delay function unit 42 (OP125).

The restarting processor 43 ends the processing after performing return of a secured work area, or the like (OP126).

An error of a program that performs interrupt control from the input/output device 60, and so forth is exposed in the case that an interrupt from the input/output device 60 or hardware (CPU) or the like has occurred during this program being executed. This is not exposed in the case that an interrupt from the input/output device 60 or hardware (CPU) or the like has not occurred.

The interrupt delay function from the input/output device 60 according to the second embodiment enables an interrupt from the input/output device 60 to be delayed intentionally until this program is executed.

Therefore, a situation for generating an interrupt from the input/output device 60 is created during execution of this program, which facilitates detection of an underlying program error (error relating to interrupt control).

### Third Embodiment

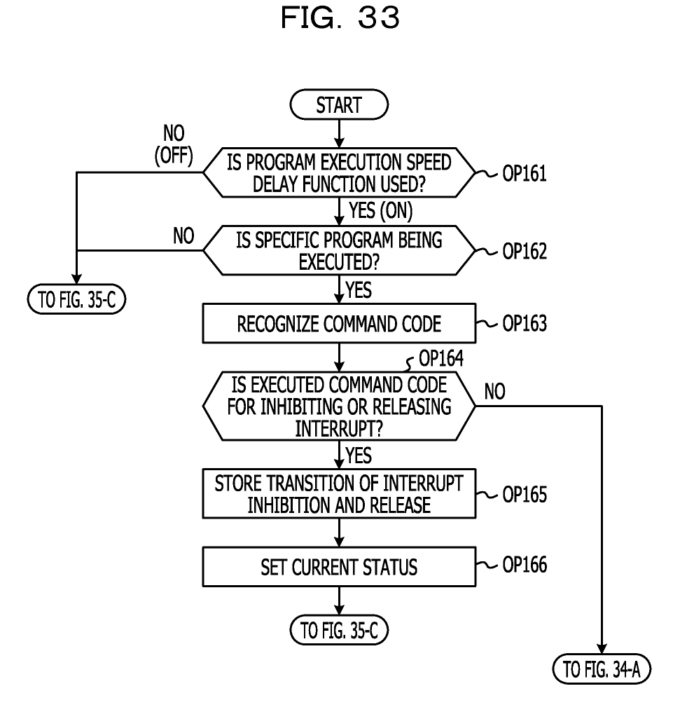

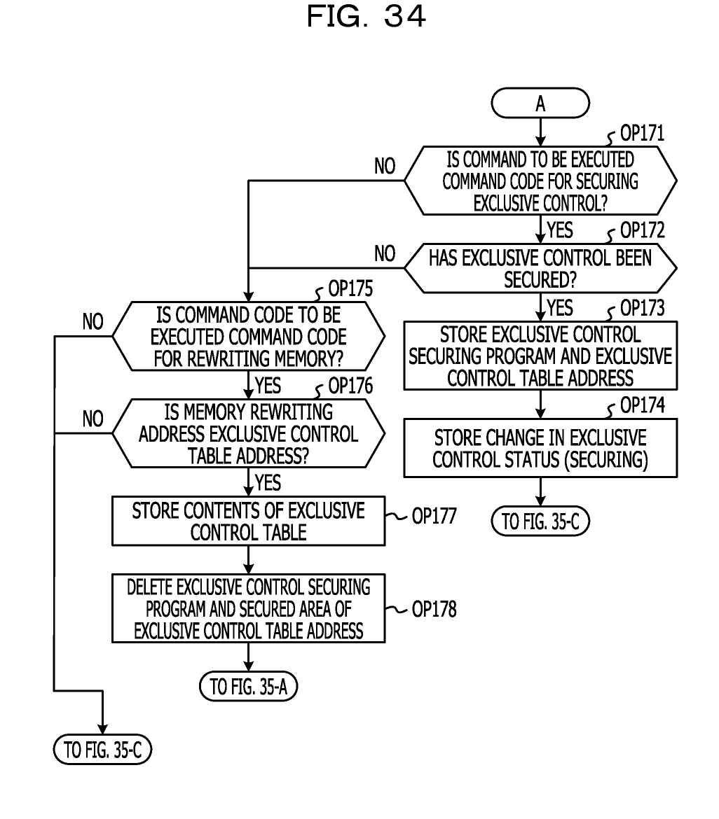

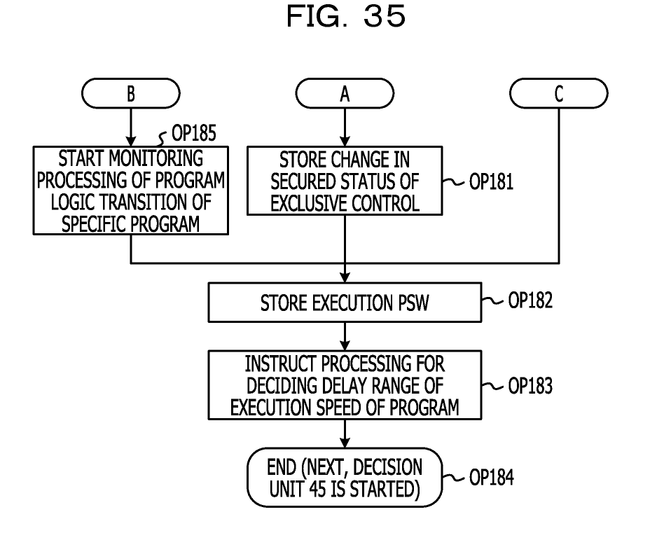

A third embodiment will describe the program execution delay function in the information processing apparatus 10, with reference to FIGS. 26 to 37.

FIG. 26 is a diagram illustrating a software configuration for realizing the program execution delay function. The monitoring unit 44, decision unit 45, fifth delay function unit 46, and emulator unit 47 described in FIG. 26 are programs obtained by dividing the third delay function unit 34 described in FIG. 3.

Upon the specific program 17 executing a command on the OS layer, the programs making up the program execution delay function are started in the order of (1) monitoring unit 44, (2) decision unit 45, and (4) emulator unit 47 in the case of not delaying the program execution speed.

Also, upon the specific program 17 executing a command on the OS layer, the programs making up the program execution delay function are started in the order of (1) monitoring unit 44, (2) decision unit 45, (3) fifth delay function unit 46, and (4) emulator unit 47 in the case of delaying the program execution speed.

The programs making up the program execution delay function perform exchange of data using the shared memory function unit 21B.

Contents specified by the user of the information processing apparatus 10 are set to the shared memory function unit 21A.

The monitoring unit 44 is a program configured to generate information used for determining a section where the program execution speed is delayed when the specific program 17 is executed.

The monitoring unit 44 monitors a command code that the specific program 17 executes to understand the transition of the program logic of the specific program 17.

The decision unit 45 references information generated by the monitoring unit 44.

The decision unit 45 decides whether to delay execution speed of a command that the specific program 17 executes, with reference to information generated by the monitoring unit 44.

The decision unit 45 delays the execution speed of the command in the case that the specific program 17 is in one of predetermined states. The predetermined states are a state from release of interrupt inhibition to setting of interrupt inhibition, a state from release of interrupt inhibition to end of a program to be tested, a state from release of exclusive control to resecuring of exclusive control, a state from release of exclusive control to end of a program to be tested, a state from setting of interrupt inhibition to securing of exclusive control, a state from release of exclusive control to release of interrupt inhibition, and a state from release of exclusive control to securing of exclusive control (within interrupt inhibition section).

In the case of not delaying the execution speed of the command, the decision unit 45 hands the control to the emulator unit 47.

In the case of delaying the execution speed of the command, the decision unit 45 calls up the fifth delay function unit 46, in order to wait for the time to elapse. Upon returning from the fifth delay function unit 46 hands the control to the emulator unit 47.

The fifth delay function unit 46 is started by being called up from the decision unit 45. The fifth delay function unit 46 waits for elapse of certain time, and after elapse of the time, returns to the requester.

The emulator unit 47 is started by the control being passed from the decision unit 45. The emulator unit 47 is an arrangement according to related art, and is configured to execute commands.

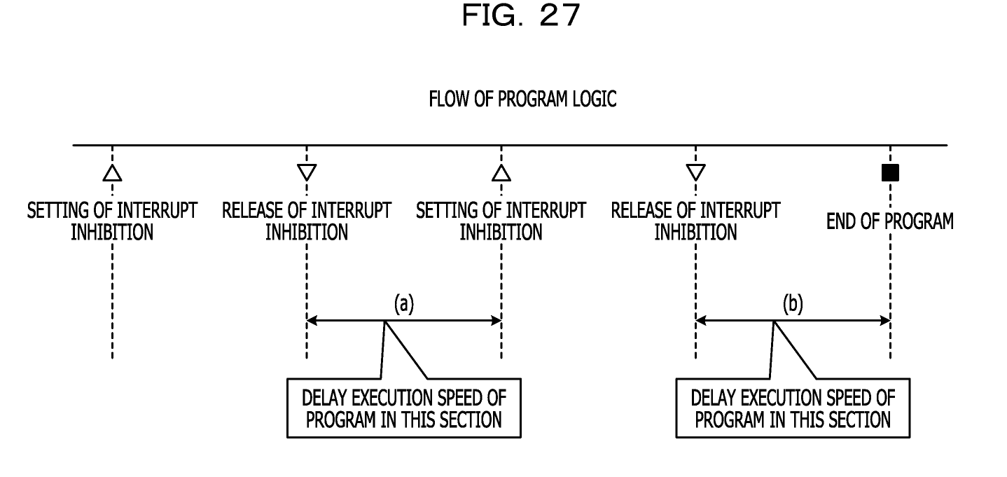

FIGS. 27 to 30 are diagrams illustrating a range where the program execution speed of the program execution delay function is delayed.

Symbols have the following meaning. Solid line arrow means flow of time. White triangle means when inhibiting an interrupt. White reverse triangle means when releasing interrupt inhibition. Black square means when ending the program. Black triangle means when securing exclusive control. Black reverse triangle means when releasing securing of exclusive control.

FIG. 27 illustrates a range where the program execution speed of a program that performs interrupt control (inhibition or release) is delayed, and a range where the program execution speed is not delayed.

The program execution speed is delayed within the following ranges.

(a) Release of interrupt inhibition to setting of interrupt inhibition

(b) Release of interrupt inhibition to end of a program to be tested

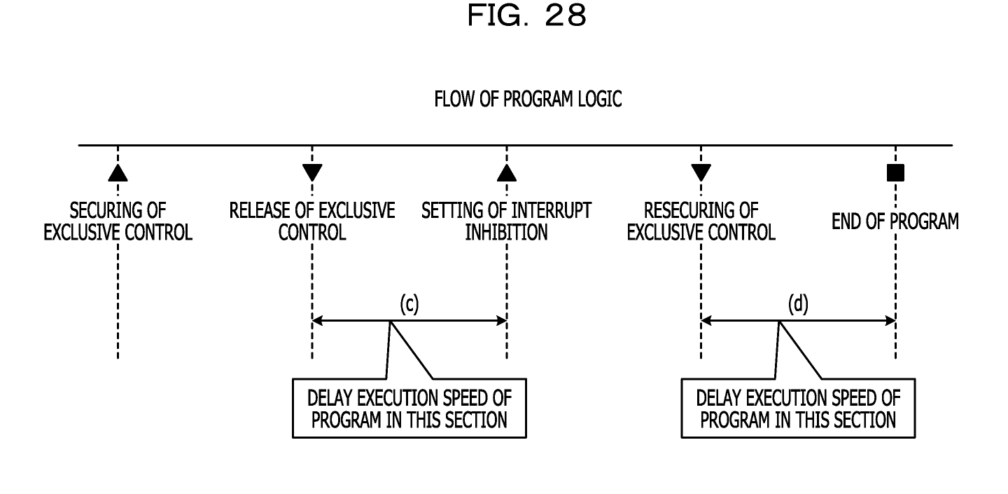

FIG. 28 illustrates a range where the program execution speed of a program that performs securing and release of exclusive control is delayed, and a range where the program execution speed is not delayed.

The program execution speed is delayed within the following ranges.

(c) Release of exclusive control to resecuring exclusive control

(d) Release of exclusive control to end of a program to be tested

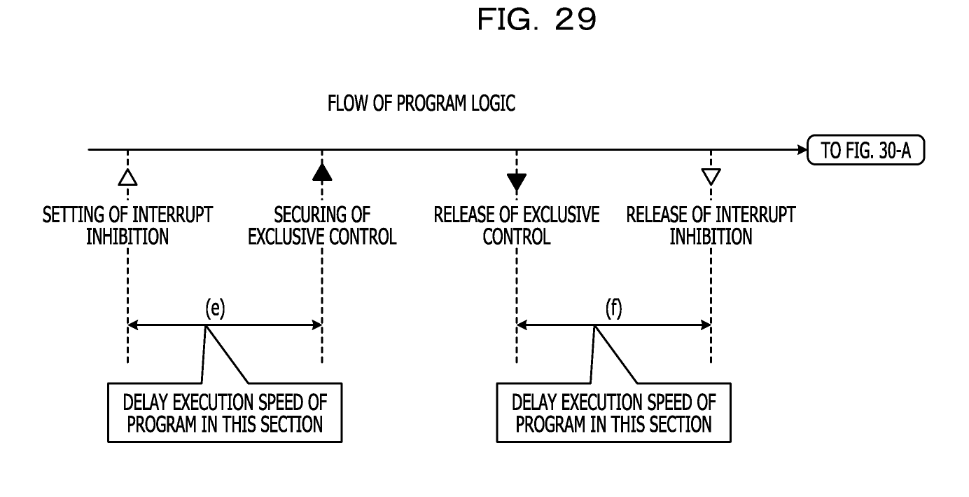

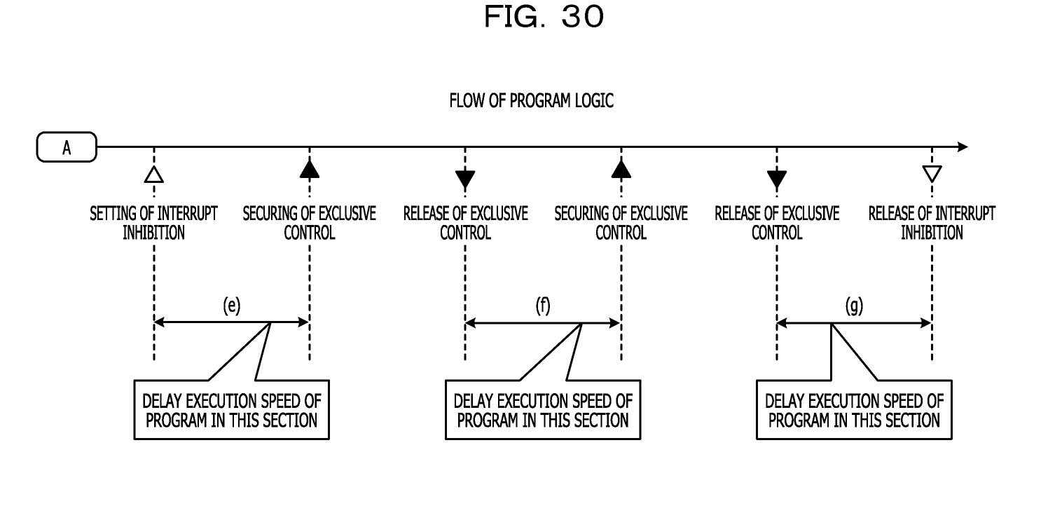

FIGS. 29 and 30 illustrate a range where the program execution speed of a program that performs interrupt control (inhibition or release) and securing and release of exclusive control is delayed, and a range where the program execution speed is not delayed.

The program execution speed is delayed within the following ranges.

(e) Setting of interrupt inhibition to securing of exclusive control

(f) Release of exclusive control to release of interrupt inhibition

(g) Release of exclusive control to securing of exclusive control (within interrupt inhibition section)

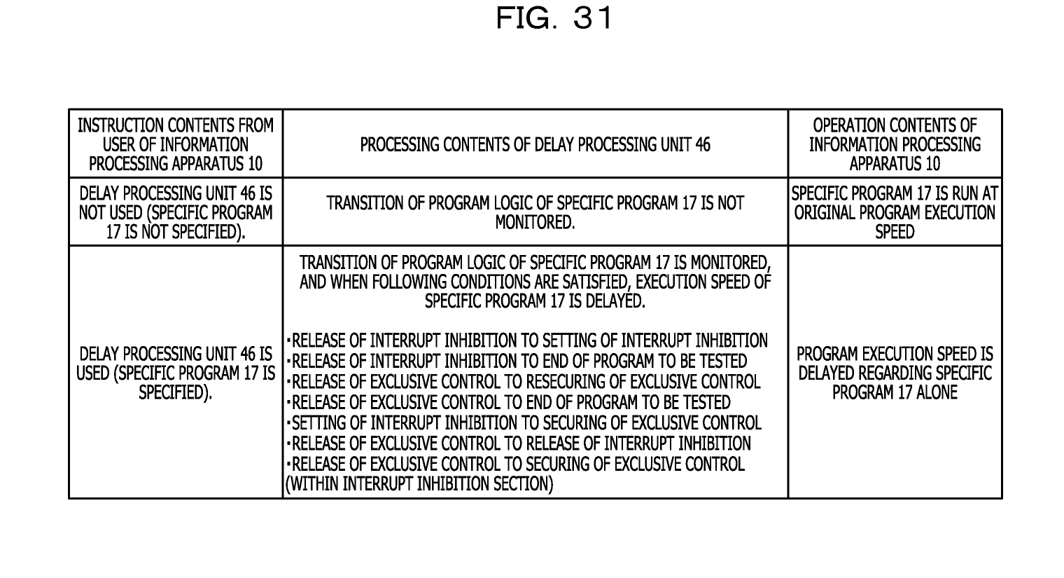

FIG. 31 is a table illustrating the processing overview of the program execution delay function.

In FIG. 31, the same configurations as the configurations described in FIGS. 1 to 30 will be denoted with the same reference numerals, and description will be omitted.

In the case that the user of the information processing apparatus 10 does not use the program execution delay function, the program operates at the original execution speed.

In the case that the user of the information processing apparatus 10 uses the program execution delay function, the execution speed is delayed when the specified program goes into one of predetermined states. The predetermined states are a state from release of interrupt inhibition to setting of interrupt inhibition, a state from release of interrupt inhibition to end of a program to be tested, a state from release of exclusive control to resecuring of exclusive control, a state from release of exclusive control to end of a program to be tested, a state from setting of interrupt inhibition to securing of exclusive control, a state from release of exclusive control to release of interrupt inhibition, and a state from release of exclusive control to securing of exclusive control (within interrupt inhibition section).

Note that programs other than the specified program run at their originally intended speeds.

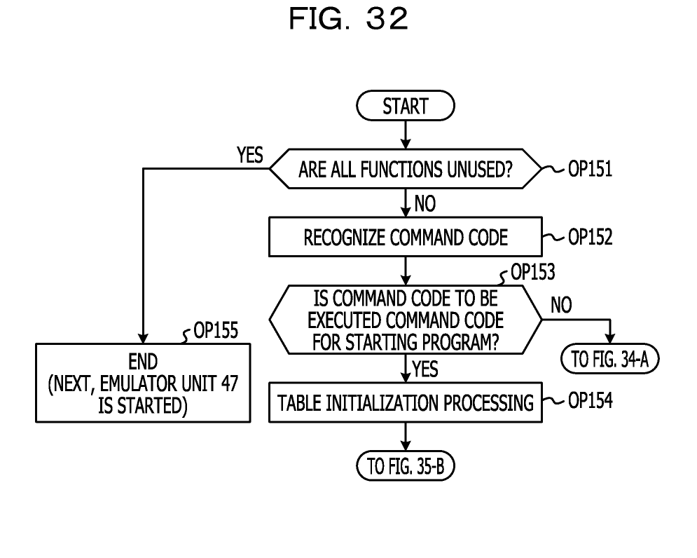

FIGS. 32 to 37 are flowcharts of the programs making up the program execution delay function.

FIGS. 32 to 35 are flowcharts of the monitoring unit 44.

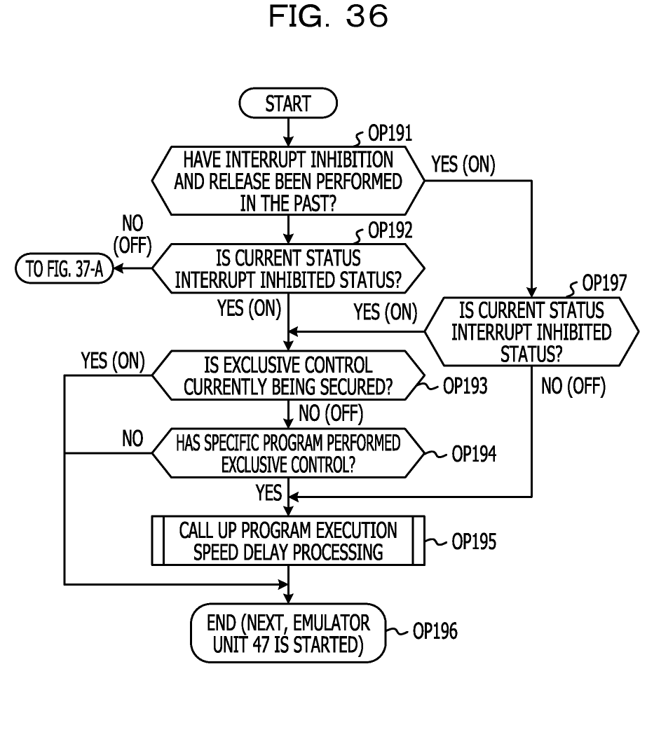

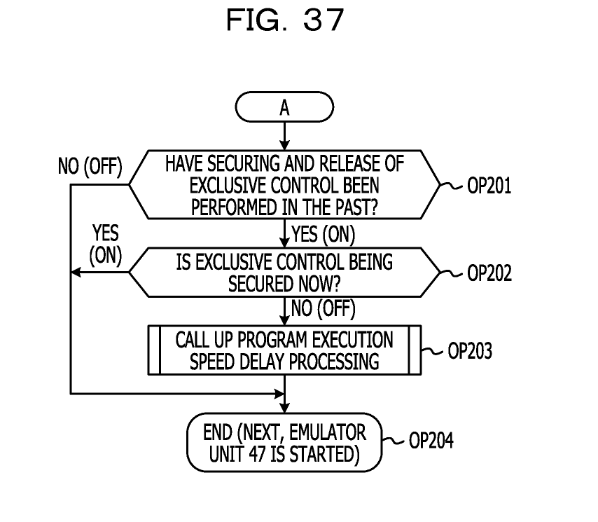

FIGS. 36 and 37 are flowcharts of the decision unit 45.

In order to facilitate understanding of description, let us assume that the specific program 17 is specified as a program to be tested from the user of the information processing apparatus 10.

The program execution delay function performs reference and updating of tables described in FIGS. 42 to 47 and 49.

Upon the specific program 17 having executed a command, the monitoring unit 44 operates (see FIG. 26). The monitoring unit 44 determines whether or not the user of the information processing apparatus 10 use none of the program starting delay function, interrupt delay function from the input/output device 60, and program execution delay function (OP151).

In the case of using none of the functions (NO in OP151), the monitoring unit 44 hands the control to the emulator unit 47 without doing anything (OP155).

In the case of using one of the functions (YES in OP151), the monitoring unit 44 recognizes the command code executed by the specific program 17 (OP153).

The monitoring unit 44 determines whether or not the command code executed by the specific program 17 is a command code for starting a program (OP153).

In the case that the command code is not a command code for starting a program (NO in OP153), the monitoring unit 44 performs processing in OP161.

In the case that the command code is a command code for starting a program (YES in OP153), the monitoring unit 44 performs default setting of a table described in FIG. 45 (control table provided to each processor function unit) (OP155).

Areas to be initialized are as follows.

1. Execution status display of the running specific program 17

2. Status display of the running specific program 17

3. Information regarding the specific program 17

4. The start address of the storage area of the specific program 17

5. The end address of the storage area of the specific program 17

6. The start address of the storage area of the other program 18 which runs in parallel

7. The end address of the storage area of the other program 18 which runs in parallel

8. The start address of the storage area of a program that generates an interrupt during running

9. The end address of the storage area of a program that generates an interrupt during running

10. The Number of information evacuation areas for exclusive control which is being used

In the case that the program to be started is a program specified by the user of the information processing apparatus 10, the monitoring unit 44 performs the following processing.

1. Turn on the execution state of the starting command of the specific program 17 of the state display area of the running specific program 17

2. Set information regarding the specific program 17

3. Set the start address of the storage area of the specific program 17

4. Set the end address of the storage area of the specific program 17

5. Set the start address of the storage area of the other program 18 which runs in parallel

6. Set the end address of the storage area of the other program 18 which runs in parallel

In the case that the program to be started is a program specified by the user, the monitoring unit 44 does not perform any processing (the execution status of the starting command of the specific program 17 is maintained to off).

Thereafter, the monitoring unit 44 performs processing in OP185.

In the case that the command code executed by the specific program 17 is not a command code for starting a program (NO in OP153), the monitoring unit 44 determines whether or not the user of the information processing apparatus 10 uses the program execution delay function (OP161).

In the case that the user does not use the program execution delay function (NO in OP161), the monitoring unit 44 performs processing in OP182.

In the case that the user uses the program execution delay function (YES in OP161), the monitoring unit 44 determines whether or not the currently running program is the program specified by the user of the information processing apparatus 10 (OP162).

In the case that the program specified by the user of the information processing apparatus 10 is not being executed (NO in OP162), the monitoring unit 44 performs processing in OP182.

In the case that the program specified by the user of the information processing apparatus 10 is being executed (YES in OP162), the monitoring unit 44 recognizes the command code executed by the specific program 17 (OP163).

The monitoring unit 44 determines whether or not the command code executed by the specific program 17 is a command code for performing interrupt inhibition or release (OP164).

In the case of the command code for not performing interrupt inhibition or release (NO in OP164), the monitoring unit 44 performs processing in OP171.

In the case of the command code for performing interrupt inhibition or release (YES in OP164), the monitoring unit 44 updates the status of the specific program 17 in the table described in FIG. 45 in accordance with a command code for inhibiting or releasing an interrupt (OP165).

The monitoring unit 44 stores the transition of interrupt inhibition and release as the past status.

The monitoring unit 44 stores the status of the interrupt inhibition and release after execution of the command as the current status (OP166). The monitoring unit 44 updates the status of the specific program 17 in the table described in FIG. 45.

Thereafter, the monitoring unit 44 performs processing in OP182.

In the case that the command code to be executed is a command code for not performing interrupt inhibition or release (NO in OP164), the monitoring unit 44 determines whether or not the command code to be executed is a command code for securing exclusive control (OP171).

In the case that the command code is not a command code for securing exclusive control (NO in OP171), the monitoring unit 44 performs processing in OP175.

In the case that the command code is a command code for securing exclusive control (YES in OP171), the monitoring unit 44 determines whether or not the current status is a status in which exclusive control is securable (OP172).

In the case of a status in which exclusive control is not securable (NO in OP172), the monitoring unit 44 performs processing in OP175.

In the case of a status in which exclusive control is securable (YES in OP172), the monitoring unit 44 updates the status of the specific program 17 in the table described in FIG. 45.

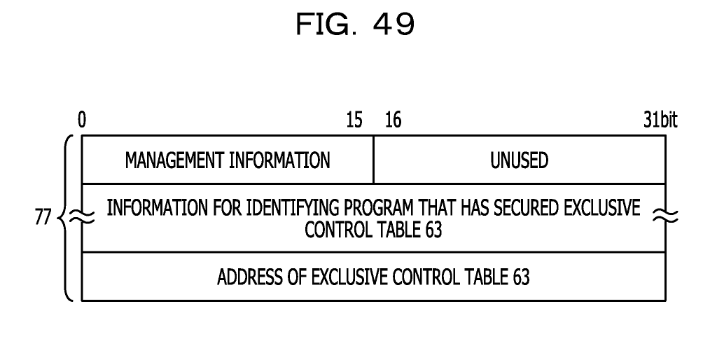

The monitoring unit 44 secures the table described in FIG. 49, and stores information for identifying a program that has secured exclusive control, such as the address of a command for securing exclusive control, or the address of a table for exclusive control (OP173).

The monitoring unit 44 stores the transition of exclusive control as the past status.

Also, the monitoring unit 44 stores the status of exclusive control after execution of the command as the current status (OP174).

The monitoring unit 44 updates the status of the specific program 17 in the table described in FIG. 45.

Thereafter, the monitoring unit 44 performs processing in OP182.

In the case that the command code to be executed is not a command code for securing exclusive control (NO in OP171), or in the case that exclusive control is not securable (NO in OP172), in order to determine whether or not the command code is a command code for releasing securing of exclusive control, the monitoring unit 44 determines whether or not the command is a command for rewriting the contents of the memory (OP175).

In the case that the command is not a command for rewriting the contents of the memory (NO in OP175), the monitoring unit 44 performs processing in OP182.

In the case that the command is a command for rewriting the contents of the memory (YES in OP175), in order to determine whether or not the command code is a command code for releasing securing of exclusive control, the monitoring unit 44 determines whether or not the memory to be rewritten is the table for exclusive control (OP176).

In the case of other than the table for exclusive control (NO in OP176), the monitoring unit 44 performs processing in OP182.

In the case of the table for exclusive control (YES in OP176), the command code to be executed is a command code for releasing securing of exclusive control, so in order to sample log information data, the monitoring unit 44 copies the contents of the table for exclusive control onto log information data (OP177).

The monitoring unit 44 releases the table described in FIG. 49 secured in the processing in OP173 (OP178).

The monitoring unit 44 stores the transition of securing or release of exclusive control as the past status. Also, the monitoring unit 44 stores the status of exclusive control after execution of the command as the current status (OP181).

The monitoring unit 44 updates the status of the specific program 17 in the table described in FIG. 45. Thereafter, the monitoring unit 44 performs processing in OP182.

In order to enable the status of the own processor to be referenced at another processor, the monitoring unit 44 records the contents of the current Program Status Word (PSW) in the table described in FIG. 45 (OP182).

In order to prepare exchange parameters for the decision unit 45, the monitoring unit 44 generates exchange parameters (OP183).

Note that there is no exchange parameter from the monitor unit 44 to the decision unit 45 now.

The monitoring unit 44 hands the control to the decision unit 45.

There may be a program that runs in an interrupt inhibition state from starting of the program. In order to handle such a program, the monitoring unit 44 performs the following processing in accordance with the contents of parameters at the time of starting of the program (OP185).

In the case of a program which runs in an interrupt inhibition state from starting of the program, the monitoring unit 44 performs default setting of the status display of the running specific program 17 in the table described in FIG. 45. The current interrupt inhibition status existing in the status display of the running specific program 17 (first bit) is on as the default value.

FIGS. 36 and 37 are flowcharts of the decision unit 45 serving as the program execution delay function.

FIG. 26 illustrates a software configuration of the program execution delay function.

In order to facilitate understanding of description, let us assume that the specific program 17 has been specified as a program to be tested from the user of the information processing apparatus 10.

The program execution delay function performs reference and updating of the table or memory map described in FIGS. 42 to 47 and 49.

The decision unit 45 is started when the control is passed from the monitoring unit 44, and is configured to decide whether or not execution speed is delayed for each step.

The decision unit 45 determines whether or not the specific program 17 has performed interrupt inhibition and release in the past (OP191).

In the case that interrupt inhibition and release have been performed in the past (YES in OP191), the decision unit 45 performs processing in OP197.

In the case that interrupt inhibition and release have not been performed in the past (NO in OP191), the decision unit 45 determines whether or not the current status is the interrupt inhibition status (OP192).

In the case that the current status is not the interrupt inhibition status (NO in OP192), the decision unit 45 performs processing in OP201.

In the case that the current status is the interrupt inhibition status (YES in OP192 or YES in OP197), the decision unit 45 determines whether or not exclusive control is secured now (OP193).

In the case that exclusive control is secured (YES in OP193), the decision unit 45 hands the control to the emulator unit 47.

In the case that exclusive control is not secured (NO in OP193), the decision unit 45 determines whether or not the currently running program is a program having exclusive control processing (OP194).

In the case that the currently running program is a program having no exclusive control processing (NO in OP194), the decision unit 45 hands the control to the emulator unit 47.

In the case that the currently running program is a program having exclusive control processing (YES in OP194), the decision unit 45 calls up the program execution speed delay processing to delay execution of the command (OP195).

Upon returning from the program execution speed delay processing, the decision unit 45 hands the control to the emulator unit 47 (OP196).

In the case that interrupt inhibition and release have been performed in the past (YES in OP191), the decision unit 45 determines whether or not the current status is the interrupt inhibition status (OP197).

In the case of the interrupt inhibition status (YES in OP197), the decision unit 45 performs processing in OP193.

In the case that the current status is not the interrupt inhibition status (NO in OP197), the decision unit 45 calls up the program execution speed delay processing to delay execution of the command (OP195).

Upon returning from the program execution speed delay processing, the decision unit 45 hands the control to the emulator unit 47 (OP196).

In the case that interrupt inhibition has not been performed even once in the past (NO in OP192), the decision unit 45 determines whether or not securing and release of exclusive control have been performed in the past (OP201).

In the case that securing and release of exclusive control have not been performed in the past (NO in OP201), the decision unit 45 hands the control to the emulator unit 47 (OP204).

In the case that securing and release of exclusive control have been performed in the past (YES in OP201), the decision unit 45 determines whether or not securing of exclusive control is being performed now (OP202).

In the case that securing of exclusive control is being performed now (YES in OP202), the decision unit 45 hands the control to the emulator unit 47 (OP204).

In the case that securing of exclusive control is not being performed (NO in OP202), the decision unit 45 calls up the program execution speed delay processing to delay execution of the command (OP203).

Upon returning from the program execution speed delay processing, the decision unit 45 hands the control to the emulator unit 47 (OP204).

According to processing for determining a range where the execution speed of the specific program 17 of the information processing apparatus 10 according to the third embodiment is delayed, an error of the specific program 17 in control of interrupt inhibition or release of interrupt inhibition, and securing of exclusive control or release of exclusive control frequently relates to timing, such that timing for setting interrupt inhibition is slow or timing for releasing interrupt inhibition is fast, timing for securing exclusive control is slow or timing for releasing exclusive control is fast, or the like.

Therefore, an error of the specific program 17 in control of interrupt inhibition or release of interrupt inhibition, and securing of exclusive control or release of exclusive control is exposed when executing multiple programs in parallel.

Also, a section where an error of the specific program 17 is exposed is very short, so it is difficult to detect an error of the specific program 17.

The present processing enables a section where an error of the specific program 17 is exposed to be expanded by delaying the program execution speed in a section illustrated in FIGS. 36 to 39. Another program is executed in parallel within this section, thereby facilitating exposure of underlying errors in the specific program 17.

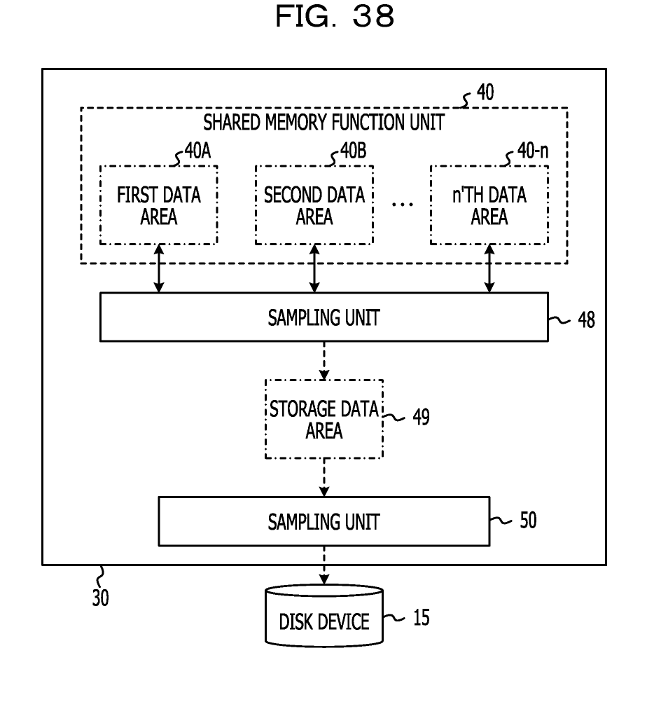

FIG. 38 is a diagram illustrating a program configuration making up log information data sampling function.

The first data area 40A to n′th data area 40n correspond to the processor function units, and are created in the shared memory function unit 40. The first data area 40A to n′th data area 40n store the information of each processor function unit (see FIG. 45).

A sampling unit 48 is configured to extract effective information from the first data area 40A to n′th data area 40n, and to copy the extracted data to a storage data area 49.

Note that examples of the effective information include data usable for cause investigation in the case that a trouble phenomenon has occurred, for example, such as data indicating the status of another processor function unit (CPU) at the time of change in the status of the program to be tested, data from which the test situation of the program to be tested is confirmable, and so forth.

The storage data area 49 is a work area used for summarizing sampled log information data, and outputting to the disk device 15. The storage data area 49 is created in the shared memory function unit 40.

An output unit 50 is configured to output the log information data sampled in the storage data area 49 to the disk device 15.

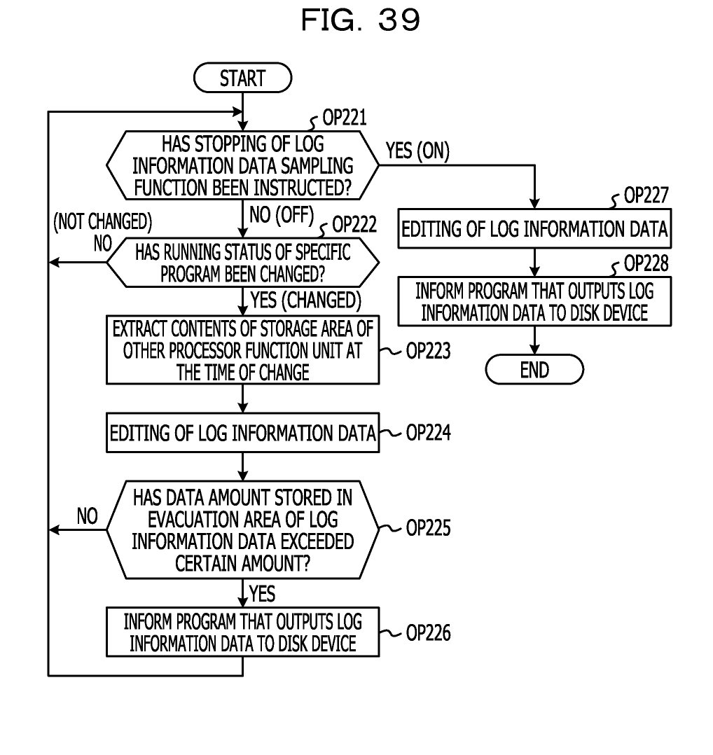

FIG. 39 is a flowchart of the sampling unit 48 serving as the log information sampling function.

The sampling unit 48 is a program configured to extract effective information from the work area of each processor function unit (the first data area 40A to n′th data area 40n in FIG. 38).

The log information data sampling function performs reference and updating of the tables and memory map described in FIGS. 42 to 47, and 49 to 52.

The sampling unit 48 determines whether or not stopping of the log information data sampling function has been specified from the user of the information processing apparatus 10 (OP221).

In the case that stopping of the log information data sampling function has not been specified (NO in OP221), the sampling unit 48 performs processing in OP222.

In the case that stopping of the log information data sampling function has been specified (YES in OP221), the sampling unit 48 completes remaining sampled log information data (OP227).

The sampling unit 48 informs the completed log information data to the output unit 50 to output to the disk device 15 (OP228).

In the case that stopping of the log information data sampling function has not been specified (NO in OP221), the sampling unit 48 determines whether or not the status of the specific program 17 has been changed (OP222).

In the case that the status of the specific program 17 has not been changed (NO in OP222), the sampling unit 48 performs the processing in OP221.

In the case that the status of the specific program 17 has been changed (YES in OP222), the sampling unit 48 extracts effective information from the work area of each processor function unit (the first data area 40A to n′th data area 40n in FIG. 38) (OP223).

The sampling unit 48 edits and stores the data extracted from the work area of each processor function unit in the storage data area 49 (OP224).

The sampling unit 48 determines whether or not data amount stored in the storage data area 49 has reached equal to or greater than unit amount to be output to the disk device 15 (OP225).

In the case of less than the unit amount to be output (NO in OP225), the sampling unit 48 performs the processing in OP221.

In the case that the data amount stored in the storage data area 49 has reached equal to or greater than unit amount to be output to the disk device 15 (YES in OP225), the sampling unit 48 informs the log information data to the output unit 50 to output to the disk device 15 (OP226), following which performs the processing in OP221.

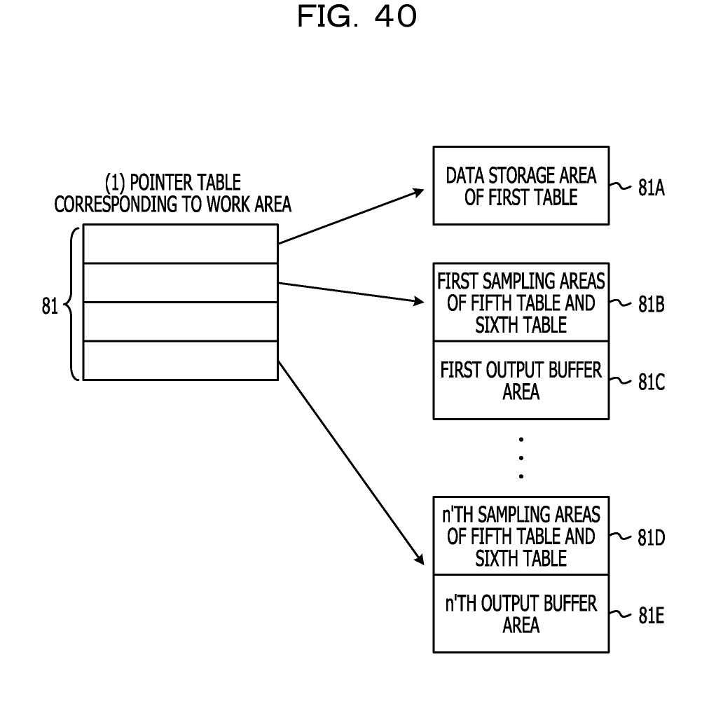

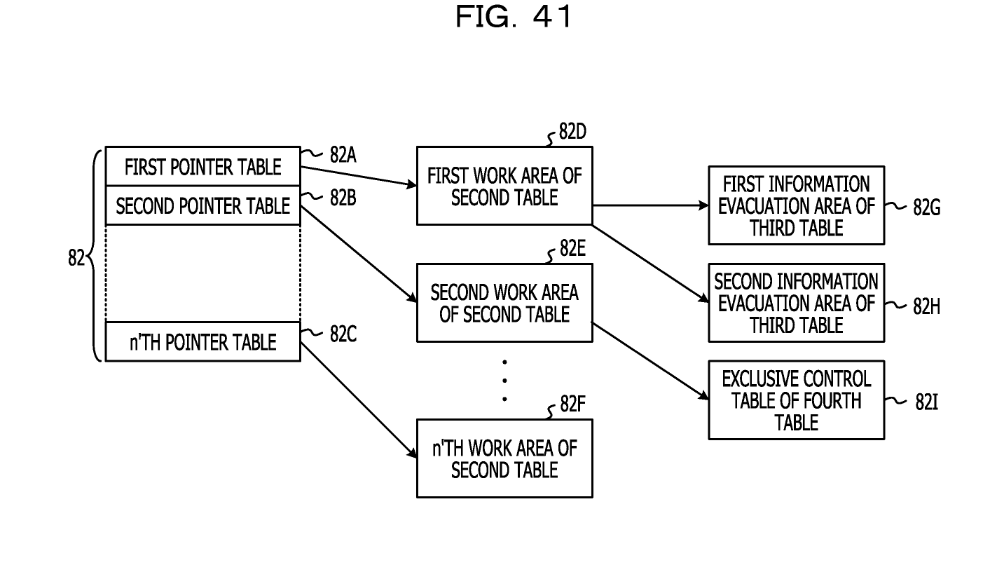

FIGS. 40 and 41 are diagrams illustrating a link relation of tables used for the program starting delay function, program execution delay function, and interrupt delay function from the input/output device 60, according to the present technology.

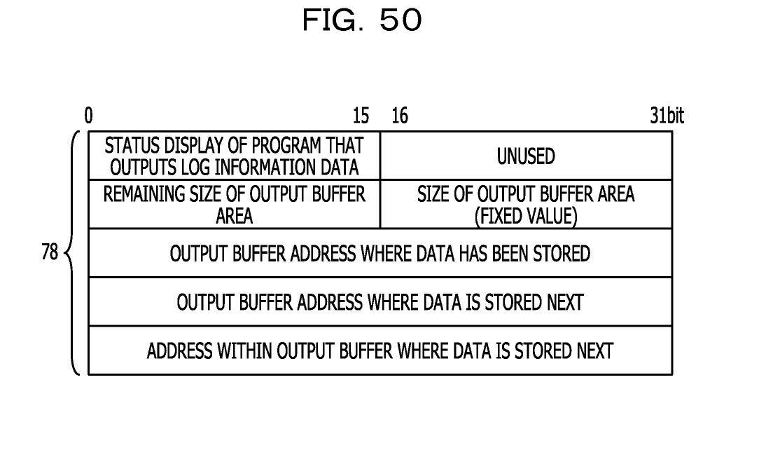

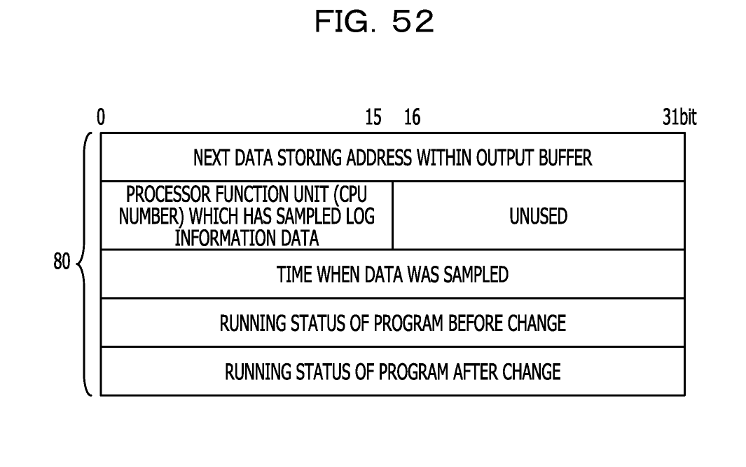

A pointer table 81 as to the work areas in FIG. 40 is configured to store the addresses of a first memory map 71 indicating the information of the function specified by the user (FIG. 42), a fifth table 78 indicating the management information of log information data (FIG. 50), and a sixth table 80 (FIG. 52) indicating the contents of the storage data area 49 for log information data.

Referencing the pointer table 81 enables the location of each table to be understood. Note that there may be provided two or more tables regarding the fifth table 78 indicating the management information of log information data (FIG. 50), and the sixth table 80 (FIG. 52) indicating the contents of the storage data area 49 for log information data.

A pointer table 82 in FIG. 41 is a table configure to correlate each processor function unit (CPU) and a second table 73 which is a control table provided to each processor function unit.

The pointer table 82 is created in the order of processor numbers (CPU numbers).

Referencing the pointer table 82 enables the location of the control table provided to each processor function unit to be understood.

The second table 73 which is a control table provided to each processor function unit is linked to the third table 76 used for the interrupt delay function (FIG. 48), and a fourth table 77 indicating the contents of exclusive control.

There may be created two or more tables regarding the third table 76 used for the interrupt delay function (FIG. 48) and the fourth table 77 indicating the contents of exclusive control.

Note that the third table 76 used for the interrupt delay function (FIG. 48) is created by the interrupt delay function from the input/output device 60, and the fourth table 77 indicating the contents of exclusive control is created by the program starting delay function.

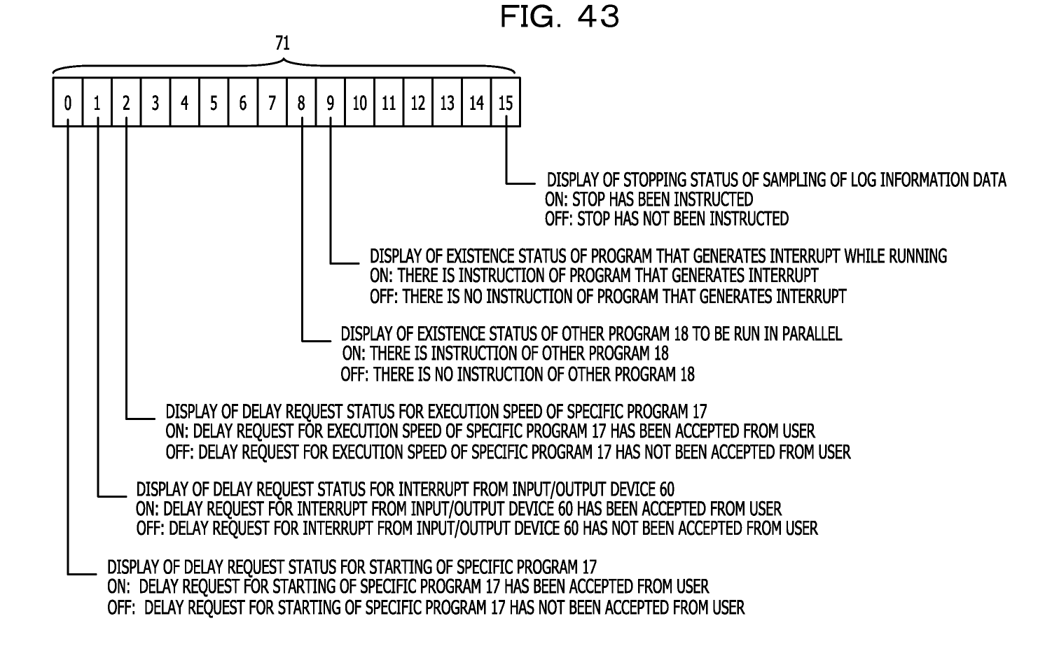

FIGS. 42 and 43 are diagrams illustrating the contents of the first memory map 71 which indicates the information of the function specified by the user. Undescribed portions are unused.

The present table is a table configured to store data specified by the user of the information processing apparatus 10. Principal contents will be described below.

0′th Bit of Information (offset position: X′00′) of Function Specified by User

The present bit is turned on in the case that use of the program starting delay function has been specified by the user of the information processing device 10.

The present bit is used for determining whether or not use of the program starting delay function has been specified by the user of the information processing device 10.

First Bit of Information (offset position: X′00′) of Function Specified by User

The present bit is turned on in the case that use of the interrupt delay function from the input/output device 60 has been specified by the user of the information processing device 10.

The present bit is used for determining whether or not use of the interrupt delay function from the input/output device 60 has been specified by the user of the information processing device 10.

Second Bit of Information (Offset Position: X′00′) of Function Specified by User

The present bit is turned on in the case that use of the program execution delay function has been specified by the user of the information processing device 10.

The present bit is used for determining whether or not use of the program execution delay function has been specified by the user of the information processing device 10.

Eighth Bit of Information (Offset Position: X′00′) of Function Specified by User

The present bit is turned on in the case that a program to be run in parallel has been specified in the instructions for use of the program starting delay function by the user of the information processing apparatus 10.

The present bit is used for the program starting delay function determining whether or not the program to be run in parallel has been specified.

Ninth Bit of Information (Offset Position: X′00′) of Function Specified by User

The present bit is turned on in the case that a program to generate an interrupt while running has been specified in the instructions for use of the interrupt delay function from the input/output device 60 by the user of the information processing apparatus 10.

The present bit is used for the interrupt delay function from the input/output device 60 determining whether or not the program to generate an interrupt while running has been specified.

15′Th Bit of Information (Offset Position: X′00′) of Function Specified by User

The present bit is turned on in the case that sampling of log information data has been stopped from the user of the information processing apparatus 10.

The present bit is used for the log information data sampling function determining whether or not stop has been specified.

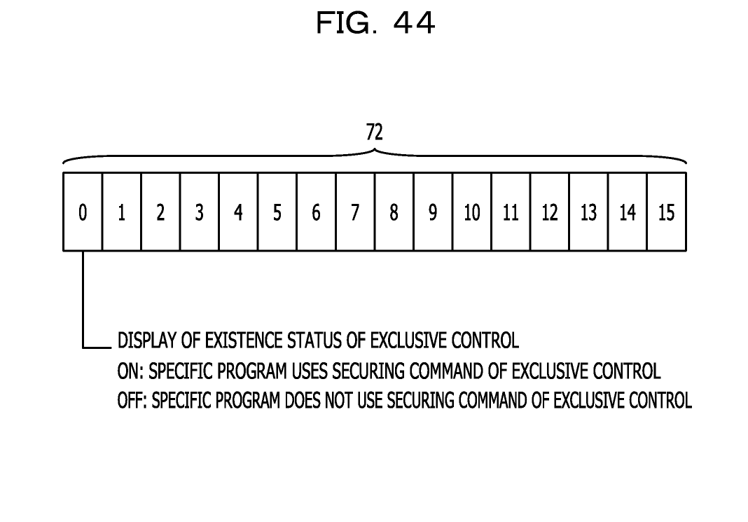

FIGS. 42 and 44 are diagrams illustrating the contents of information regarding the specific program 17. Undescribed portions are unused.

0′Th Bit of Information (Offset Position: X′02′) Regarding Specific Program 17

The present bit is turned on in the case that a program specified in the instructions for use of the program execution delay function from the user of the information processing apparatus 10 has a logic to perform exclusive control.

The present bit is used for the program execution delay function determining whether or not there is a possibility that the program will perform exclusive control.

The start address of an area including the specific program 17, and the end address of the area including the specific program 17, are used for determining whether or not the specified program is a program serving as an object of the program execution delay function.

The start address of an area including the other program 18 to be run in parallel, and the end address of the area including the other program 18 to be run in parallel are used for the program starting delay function determining whether to delay starting of the specified program.

The start address of an area including a program to generate an interrupt while running, and the end address of the area including a program to generate an interrupt while running are used for the interrupt delay function from the input/output device 60 determining whether to generate or delay the interrupt when an interrupt from the input/output device 60 occurs.

FIGS. 45 to 47 are the contents of a control table provided to each processor function unit.

The present table is a table in which the status of the corresponding processor function unit is stored.

Principal contents will be described below.

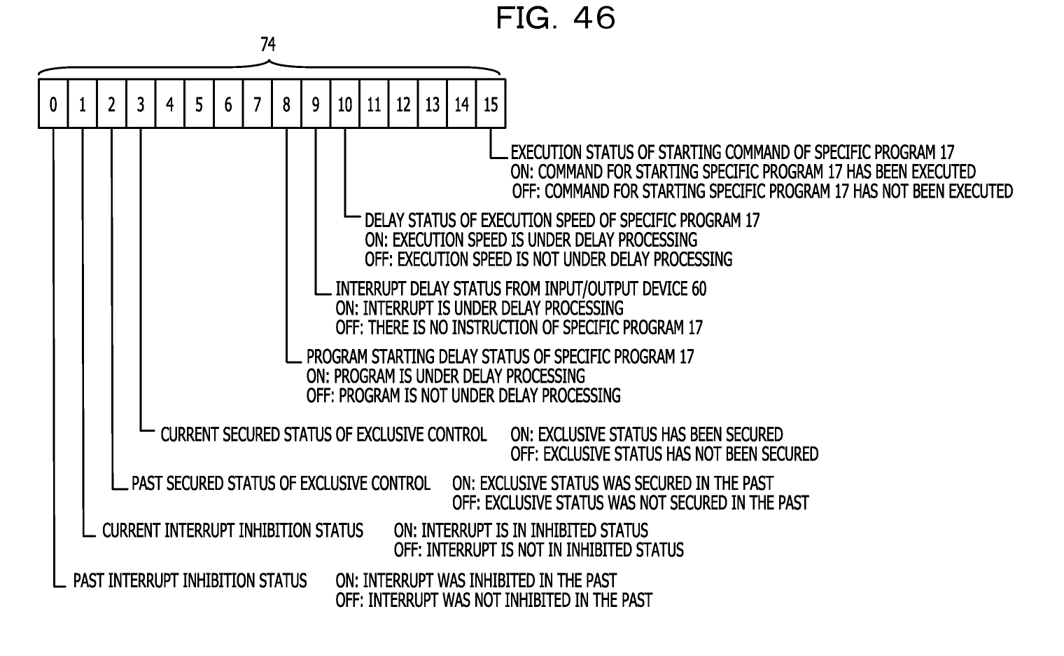

FIGS. 45 and 46 are diagrams illustrating contents of the status display of the running specific program 17. Undescribed portions are unused.

0′th Bit of Status Display (Offset Position: X′00′) of Running Specific Program 17

The present bit is turned on in the case that the target program has performed interrupt inhibition or release in the past.

The present bit is used for the program execution delay function determining whether or not the target program has performed interrupt inhibition or release in the past.

First Bit of Status Display (Offset Position: X′00′) of Running Specific Program 17

The present bit is turned on in the case that the target program is performing interrupt inhibition.

The present bit is used for the program execution delay function determining whether or not the target program is performing interrupt inhibition.

Second Bit of Status Display (Offset Position: X′00′) of Running Specific Program 17

The present bit is turned on in the case that the target program has performed securing or release of exclusive control in the past.

The present bit is used for the program execution delay function determining whether or not the target program has performed securing or release of exclusive control in the past.

Third Bit of Status Display (Offset Position: X′00′) of Running Specific Program 17

The present bit is turned on in the case that the target program is performing securing of exclusive control now.

The present bit is used for the program execution delay function determining whether or not the target program is performing securing of exclusive control.

Eighth Bit of Status Display (Offset Position: X′00′) of Running Specific Program 17

The present bit is turned on when the corresponding processor starts the program starting delay function.

Ninth Bit of Status Display (Offset Position: X′00′) of Running Specific Program 17

The present bit is turned on when the corresponding processor starts the interrupt delay function from the input/output device 60.

Tenth Bit of Status Display (Offset Position: X′00′) of Running Specific Program 17

The present bit is turned on when the corresponding processor starts the program execution delay function.

15′Th Bit of Status Display (Offset Position: X′00′) of Running Specific Program 17

The present bit is turned on when a command for starting a program is executed at the corresponding processor.

The present bit is referenced when performing initialization processing of the control tables provided to a processor function unit.

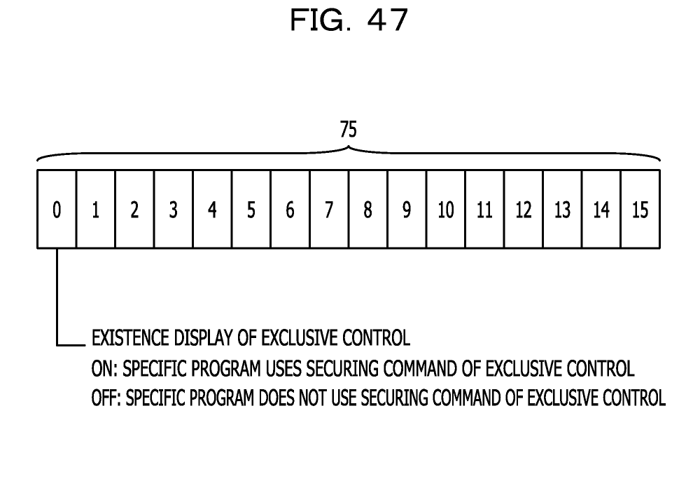

FIGS. 45 and 47 are diagrams illustrating the contents of information regarding the specific program 17. Undescribed portions are unused.

Principal contents will be described below.

0′Th Bit of Information (Offset Position: X′02′) Regarding Specific Program 17

The present bit has the same content as information regarding the specific program 17 in FIG. 42, where the information regarding the specific program 17 is copied and used.

The number of times of timer interrupts from the hardware is stored as the number of times of timer interrupts of a processor function unit. The number of times of timer interrupts of a processor function unit is used for recognizing elapse of time.

The contents of the PSW of a processor function unit are stored for allowing another processor function to reference the status of the own processor function unit, and is used for referencing the status of another processor function unit or for recognizing the status of another processor function unit.

The start address and end address where a program which is regarded as the target of the own processor function unit is loaded are stored as the start address of the storage area of the specific program 17, and the end address of the storage area of the specific program 17.

These addresses are used for the program execution delay function recognizing the target program which is running on the own processor function unit.

For example, in the case that an address portion within the PSW of a processor function unit is in a range between the start address of the storage area of the specific program 17 and the end address of the storage area of the specific program 17, determination is made that the specific program 17 is running.

The start address of the storage area of the other program 18 to be run in parallel, and the end address of the storage area of the other program 18 to be run in parallel are used for the program starting delay function determining whether or not the other program 18 to be run in parallel on another processor function unit is being executed.

The start address of a program that generates an interrupt while running, and the end address of the program that generates an interrupt while running are used for determining whether or not a program that generates an interrupt on another processor function unit is being executed when the interrupt from the input/output device 60 occurs.

The number of input/output devices 60 of which the interrupts are delayed by the corresponding processor function unit is stored as the number of input/output device 60 of which the interrupts are delayed.

The number of times of exclusive control secured by a program serving as the target of the program execution delay function on the corresponding processor function unit is stored as the number of information evacuation areas for exclusive control which are being used.

An address of the interrupt information evacuation area from the input/output device 60 indicates the position of an area where the interrupt information from the input/output device 60 of which the interrupt is delayed at the corresponding processor function unit is evacuated (see FIG. 48). The number of areas where the interrupt information from the input/output device 60 is evacuated is equivalent to the number of input/output devices 60 of which the interrupt is being delayed.

An address of the information evacuation area for exclusive control indicates the position of an information evacuation area of exclusive control captured by a program which is regarded as the target of the program execution delay function on the corresponding processor function unit (see FIG. 49). The number of information evacuation areas for exclusive control is equivalent to the number of times of exclusive control captured by the program which is regarded as the target of the program execution delay function.

FIG. 48 is a evacuation area for interrupt information from the input/output device 60 when the interrupt from the input/output device 60 occurs, and the interrupt delay function from the input/output device 60 delays the interrupt.

The present table includes the device number of the input/output device 60 of which the interrupt has occurred, and interrupt information from the input/output device 60, and management information. Information indicating whether or not the present table is being used is provided to the management information.

FIG. 49 is an evacuation area for information of exclusive control secured by a program which is regarded as the target of the program execution delay function.

The present table includes information for identifying a program that has secured exclusive control, a table address for exclusive control, and management information. Information indicating whether or not the present table is being used is provided to the management information.

Note that the information for identifying a program that has secured exclusive control differs depending on the type of the OS.

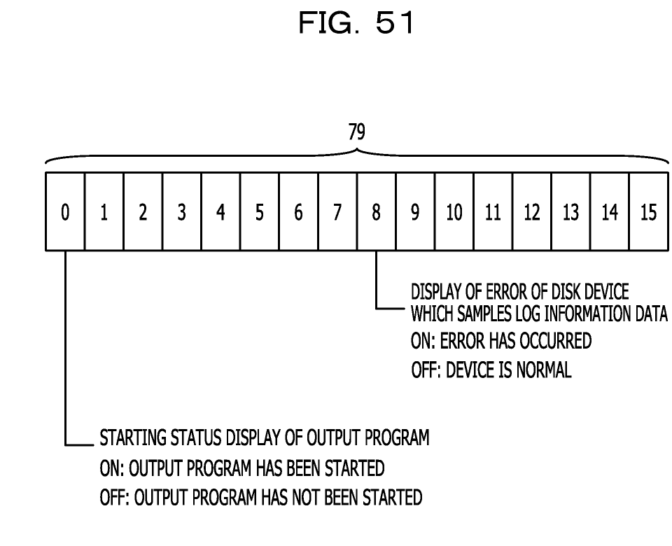

FIGS. 50 and 51 are a management table for managing log information data sampled by the log information data sampling function.

FIG. 50 describes an overall view, and FIG. 51 illustrates the contents of the status display information of a program that outputs log information data.

Principal contents will be described below.

The contents of the status display information of a program that output log information data will be described.

0′Th Bit of Status Display Information (Offset Position: X′00′) of Program Outputting Log Information Data

The present bit is turned on in the case that a program that outputs log information data has been started. The present bit is used for determining whether or not the output program has been started.

Eighth Bit of Status Display Information (Offset Position: X′00′) of Program Outputting Log Information Data

The present bit is turned on in the case that an error has occurred on the disk device which outputs log information data. The present bit is used for determining whether the disk device which outputs log information data is normal or abnormal.

FIG. 52 is a diagram illustrating the contents of the storage area of log information data.

The present table is configured to store the next data storing address within the output buffer, the number of a processor function unit (CPU number), time when data was sampled, the running status of a program before change, and the running status of the program after change.

The disclosed technology provides an information processing apparatus and an information processing apparatus control method which enable execution timing of a program to be controlled in accordance with operation of another program even when it is difficult to control execution timing of an individual program.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing system comprising:
a memory that stores a first program and a second program;
a first processor coupled to the memory and configured to execute the first program; and
a second processor coupled to the memory and configured to delay execution of the second program until the first processor starts executing the first program.

2. The information processing system according to claim 1, wherein the second processor is configured to execute the second program when the first processor is executing the first program.

3. The information processing system according to claim 1, wherein the second processor is configured to determine whether or not the first processor is executing the first program.

4. The information processing system according to claim 1, wherein the second processor is configured to emulate a command to be executed by the second processor.

5. The information processing system according to claim 1, wherein the second processor is configured to lower execution speed of the second program when the second program performs at least one of setting of interrupt inhibition and releasing of the interrupt inhibition.

6. The information processing system according to claim 1, wherein the second processor is configured to lower execution speed of the second program when the second program performs at least one of securing of exclusive control and releasing of the exclusive control.

7. The information processing system according to claim 1, wherein the second processor is configured to delay an interrupt from an input/output device when the second processor executes the second program.

8. A method executed by a computer including a memory storing a first program and a second program, and a first processor and a second processor coupled to the memory, the method comprising:
delaying execution of the second program by the second processor until the first processor starts executing the first program.

9. The method according to claim 8, further comprising:
executing the second program by the second processor when the first processor is executing the first program.

10. The method according to claim 8, further comprising:
determining whether or not the first processor is executing the first program.

11. The method according to claim 8, further comprising:
emulating a command to be executed by the second processor.

12. The method according to claim 8, further comprising:
lowering execution speed of the second program when the second program performs at least one of setting of interrupt inhibition and releasing of the interrupt inhibition.

13. The method according to claim 8, further comprising:
lowering execution speed of the second program when the second program performs at least one of securing of exclusive control and releasing of the exclusive control.

14. The method according to claim 8, further comprising:
delaying an interrupt from an input/output device when the second processor executes the second program.

15. A computer-readable recording medium storing a program that causes a computer to execute a process, the computer including a memory storing a first program and a second program, and a first processor and a second processor coupled to the memory, the process comprising:
delaying execution of the second program by the second processor until the first processor starts executing the first program.

16. The computer-readable recording medium according to claim 15, the process further comprising:
executing the second program by the second processor when the first processor is executing the first program.

17. The computer-readable recording medium according to claim 15, the process further comprising:
emulating a command to be executed by the second processor.

18. The computer-readable recording medium according to claim 15, the process further comprising:
lowering execution speed of the second program when the second program performs at least one of setting of interrupt inhibition and releasing of the interrupt inhibition.

19. The computer-readable recording medium according to claim 15, the process further comprising:
lowering execution speed of the second program when the second program performs at least one of securing of exclusive control and releasing of the exclusive control.

20. The computer-readable recording medium according to claim 15, the process further comprising:
delaying an interrupt from an input/output device when the second processor executes the second program.
